(19) United States
(12) Patent Application Publication
(10) Pub. No.: US 2012/0058401 A1
(43) Pub. Date: Mar. 8, 2012

(54) ELECTROLYTIC SOLUTION FOR SECONDARY BATTERY, SECONDARY BATTERY, ELECTRIC POWER TOOL, ELECTRICAL VEHICLE, AND ELECTRIC POWER STORAGE SYSTEM

(75) Inventors: Masayuki Ihara, Fukushima (JP); Takehiko Tanaka, Fukushima (JP); Tadahiko Kubota, Kanagawa (JP)

(73) Assignee: SONY CORPORATION, Tokyo (JP)

(21) Appl. No.: 13/210,046

(22) Filed: Aug. 15, 2011

(30) Foreign Application Priority Data
Sep. 2, 2010 (JP) 2010-196974

(51) Int. Cl. H01M 10/056; H01M 4/134; H01M 4/133

(52) U.S. Cl. 429/336

(57) ABSTRACT

A secondary battery includes a cathode, an anode, and an electrolytic solution. The electrolytic solution contains chlorine ions together with a nonaqueous solvent and an electrolyte salt. The nonaqueous solvent contains sulfonic acid anhydrides (disulfonic acid anhydride or sulfonic acid carboxylic acid anhydride). A content of the chlorine ions is 5000 wt ppm or less.

### CROSS REFERENCES TO RELATED APPLICATIONS

The present application claims priority to Japanese Priority Patent Application JP 2010-196974 filed in the Japanese Patent Office on Sep. 2, 2010, the entire contents of which is hereby incorporated by reference.

### BACKGROUND

The present application relates to an electrolytic solution for a secondary battery containing a sulfonic acid anhydride, a secondary battery using the electrolytic solution for a secondary battery, an electric power tool using the secondary battery, an electrical vehicle using the secondary battery, and an electric power storage system using the secondary battery.

In recent years, small electronic devices represented by a portable terminal or the like have been widely used, and it is strongly demanded to reduce their size and weight and to achieve their long life. Accordingly, as a power source for the small electronic devices, a battery, in particular, a small and light-weight secondary battery capable of providing a high energy density has been developed. In recent years, it has been considered to apply such a secondary battery not only to the small electronic devices but also to a large electronic devices represented by a vehicle or the like.

It has been examined to use various elements as a carrier (electrode reactant) of the secondary battery. Specially, a lithium secondary battery using lithium (Li) as an electrode reactant has been largely prospective, since such a lithium secondary battery is able to provide a higher energy density than a lead battery, a nickel cadmium battery and the like. The lithium secondary battery includes a lithium ion secondary battery using insertion and extraction of lithium ions and a lithium metal secondary battery using precipitation and dissolution of lithium metal.

The secondary battery includes a cathode, an anode, and an electrolytic solution. The electrolytic solution contains a nonaqueous solvent and an electrolyte salt. The electrolytic solution functioning as a medium for charge and discharge reaction largely affects performance of the secondary battery. Thus, various studies have been made on the composition of the electrolytic solution.

Specifically, technique in which disulfonic acid anhydride or sulfonic acid carboxylic acid anhydride or the like is contained in an electrolytic solution as an acid anhydride to improve the cycle characteristics and the like has been known (for example, see Japanese Unexamined Patent Application Publication Nos. 2004-022336, 2008-098053, and 2009-038018). Further, technique to adjust concentration of chlorine ions in an electrolytic solution to improve the cycle characteristics has been known (for example, see Japanese Unexamined Patent Application Publication No. 2001-023685).

### SUMMARY

In these years, the high performance and the multi functions of the electronic devices are increasingly developed, and usage frequency thereof is increased. Thus, the secondary battery tends to be frequently charged and discharged. Accordingly, further improvement of performance of the secondary battery, in particular, further improvement of the cycle characteristics, the storage characteristics, and the voltage characteristics of the secondary battery have been aspired.

In view of the foregoing disadvantages, in the present disclosure, it is desirable to provide an electrolytic solution for a secondary battery with which battery characteristics are able to be improved, a secondary battery, an electric power tool, a electrical vehicle, and an electric power storage system.

According to an embodiment, there is provided an electrolytic solution for a secondary battery containing chlorine ions together with a nonaqueous solvent and an electrolyte salt. The nonaqueous solvent contains one or both of sulfonic acid anhydrides expressed by Formula 1 and Formula 2. A content of the chlorine ions is 5000 wt ppm or less. Further, according to an embodiment, there is provided a secondary battery including a cathode, an anode, and an electrolytic solution. The electrolytic solution has a structure similar to that of the foregoing electrolytic solution for a secondary battery of the embodiment of the present disclosure. Further, according to an embodiment, there is provided an electric power tool, an electrical vehicle, and an electric power storage system that are used for a secondary battery having a structure similar to that of the foregoing secondary battery of the embodiment.

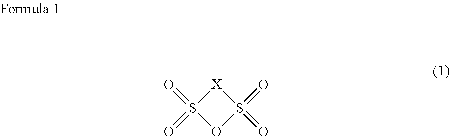

[00111 In the formula, X is a divalent hydrocarbon group or a derivative thereof

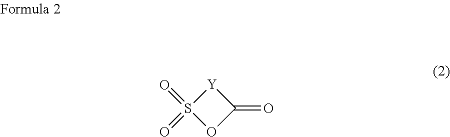

In the formula, Y is a divalent hydrocarbon group or a derivative thereof.

The electrolytic solution for a secondary battery of the embodiment contains chlorine ions together with one or both of the sulfonic acid anhydrides expressed by Formula 1 and Formula 2. The content of the chlorine ions is 5000 wt ppm or less. Thereby, even if the sulfonic acid anhydride coexists with chlorine ions, decomposition reaction of the electrolytic solution for a secondary battery is inhibited by the sulfonic acid anhydride. Therefore, according to the secondary battery using the electrolytic solution for a secondary battery of the embodiment, the electric power tool using the secondary battery, the electrical vehicle using the secondary battery, and the electric power storage system using the secondary battery, battery characteristics are able to be improved.

It is to be understood that both the foregoing general description and the following detailed description are exemplary, and are intended to provide further explanation of the technology as claimed.

Additional features and advantages are described herein, and will be apparent from the following Detailed Description and the figures.

### BRIEF DESCRIPTION OF THE FIGURES

FIG. 1 is a cross sectional view illustrating a structure of a secondary battery (cylindrical type) including an electrolytic solution for a secondary battery according to an embodiment.

FIG. 2 is a cross sectional view illustrating an enlarged part of a spirally wound electrode body illustrated in FIG. 1.

FIG. 3 is a perspective view illustrating a structure of a secondary battery (laminated film type) including the electrolytic solution for a secondary battery of the embodiment.

FIG. 4 is a cross sectional view taken along line IV-IV of the spirally wound electrode body illustrated in FIG. 3.

### DETAILED DESCRIPTION

Embodiments of the present application will be described below in detail with reference to the drawings.

An embodiment will be hereinafter described in detail with reference to the drawings. The description will be given in the following order.

1. Electrolytic solution for a secondary battery

2. Secondary battery

2-1. Lithium ion secondary battery (cylindrical type)

2-2. Lithium ion secondary battery (laminated film type)

2-3. Lithium metal secondary battery (cylindrical type and laminated film type)

3. Application of the secondary battery

1. Electrolytic Solution for a Secondary Battery

An electrolytic solution for a secondary battery according to an embodiment (hereinafter simply referred to as “electrolytic solution”) contains chlorine ions together with a nonaqueous solvent and an electrolyte salt.

Nonaqueous Solvent

The nonaqueous solvent contains at least one of the sulfonic acid anhydrides shown in Formula 1 and formula 2 (hereinafter simply referred to as “sulfonic acid anhydride”). The sulfonic acid anhydride has a function to improve chemical stability of the electrolytic solution (hereinafter simply referred to as “chemical stabilization function”). Thus, in the case where the electrolytic solution containing the sulfonic acid anhydride is used for a secondary battery, decomposition reaction of the electrolytic solution at the time of charge and discharge is inhibited.

The sulfonic acid anhydride shown in Formula 1 is a cyclic disulfonic acid anhydride obtained by dehydration and condensation of two sulfonic acid groups (sulfo group). The sulfonic acid anhydride shown in Formula 2 is a cyclic sulfonic acid carboxylic acid anhydride obtained by dehydration and condensation of a sulfonic acid group and a carboxylic acid group (carboxyl group). X in Formula 1 and Y in Formula 2 may be the same group or a group different from each other.

X and Y are not particularly limited, as long as X and Y are a divalent hydrocarbon group or a derivative thereof. The hydrocarbon group is, for example, an alkylene group, an alkenylene group, an alkynylene group, an arylene group or the like, and may be other group. The alkylene group, the alkenylene group, or the alkynylene group may be in a straight chain state or a branched state, and the carbon number thereof is not particularly limited. The derivative herein is, for example, a group obtained by substituting at least partial hydrogen group in the hydrocarbon group with a halogen group. The halogen group is one or more types among a fluorine group (—F), a chlorine group (—Cl), a bromine group (—Br), an iodine group (—I) and the like. However, the derivative is not necessarily the derivative of the foregoing groups.

Specially, X and Y are preferably the alkylene group in a straight chain state or a branched state with a carbon number from 2 to 4 both inclusive, the alkenylene group in a straight chain state or a branched state with a carbon number from 2 to 4 both inclusive, the arylene group, or a derivative thereof, since thereby superior compatibility is obtained and thus the sulfonic acid anhydride is easily mixed with other nonaqueous solvent. The derivative herein is, for example, a group obtained by substituting at least partial hydrogen group out of the alkylene group or the like with a halogen group, a group obtained by introducing other type of group (for example, other divalent hydrocarbon group or the like) to the alkylene group or the like. Types of the halogen group and the hydrocarbon group are similar to those described above.

Specific examples of the sulfonic acid anhydride shown in Formula 1 include at least one of compounds expressed by Formula (1-1) to Formula (1-19). Further, specific examples of the sulfonic acid anhydride shown in Formula 2 include at least one of compounds expressed by Formula (2-1) to Formula (2-15). However, other compound may be used.

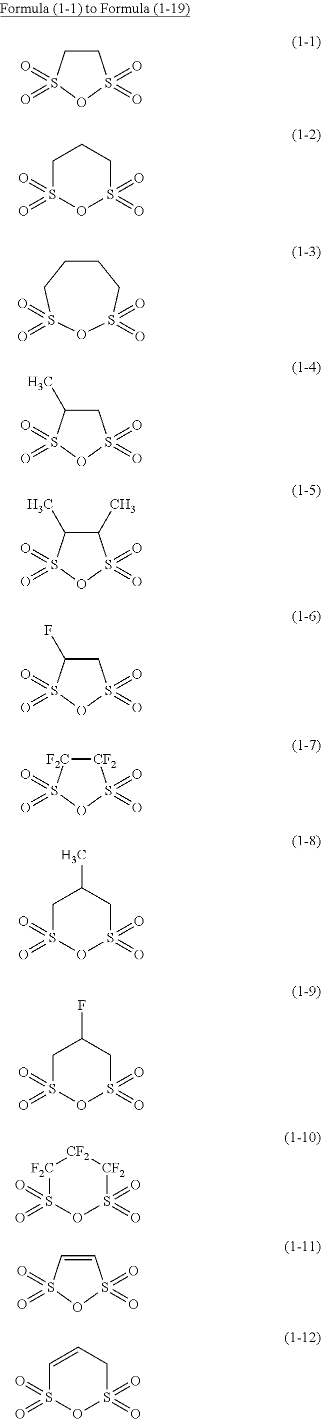

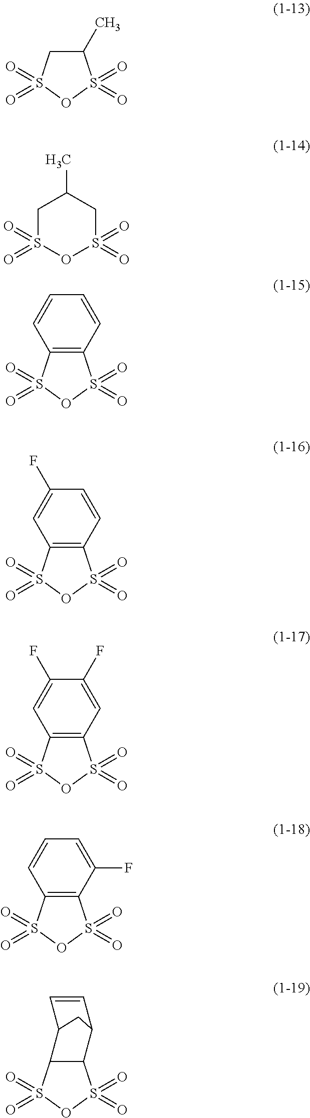

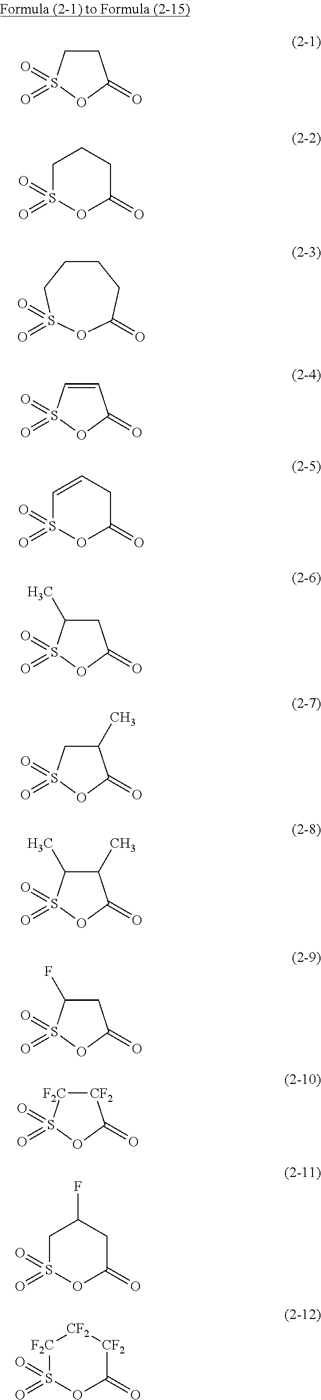

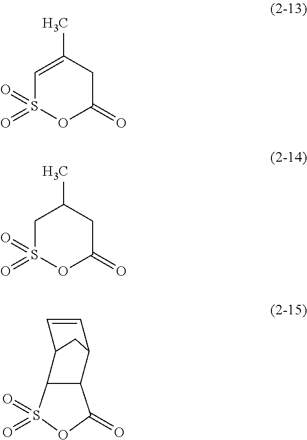

Though the content of the sulfonic acid anhydride in the nonaqueous solvent is not particularly limited, in particular, the content thereof is preferably from 0.001 wt % to 5 wt % both inclusive, since thereby decomposition reaction of the electrolytic solution is inhibited at the time of charge and discharge while original characteristics of the battery such as a battery capacity are secured.

Content of Chlorine Ions

The content of the chlorine ions in the electrolytic solution is 5000 wt ppm or less (from 0 wt ppm to 5000 wt ppm both inclusive), since thereby even if the sulfonic acid anhydride coexists with chlorine ions, the chemical stabilization function of the sulfonic acid anhydride is retained, and thus decomposition reaction of the electrolytic solution is inhibited.

More specifically, the chlorine ions specifically impair only the chemical stabilization function of the sulfonic acid anhydride. In this case, in the case where the content of the chlorine ions is more than 5000 wt ppm, even if the nonaqueous solvent contains the sulfonic acid anhydride, chemical stability of the electrolytic solution is not able to be improved by the sulfonic acid anhydride, and thus the electrolytic solution is easily decomposed at the time of charge and discharge. Meanwhile, in the case where the content of the chlorine ions is 5000 wt ppm or less, chemical stability of the electrolytic solution is able to be improved by the sulfonic acid anhydride contained in the nonaqueous solvent, and thus the electrolytic solution is less likely to be decomposed at the time of charge and discharge.

The foregoing description “the chlorine ions specifically inhibit only the chemical stabilization function of the sulfonic acid anhydride” means that the chlorine ions tend to inhibit the chemical stabilization function of the sulfonic acid anhydride, and do not tend to inhibit chemical stabilization function of compounds other than the sulfonic acid anhydride. Examples of “other compounds” include a compound synthesized by dehydration and condensation reaction as the sulfonic acid anhydride such as an unsaturated carbon bond cyclic ester carbonate described below.

The unsaturated carbon bond cyclic ester carbonate is, for example, vinylene carbonate or the like, and has chemical stabilization function as the sulfonic acid anhydride does. However, the chemical stabilization function of vinylene carbonate is not inhibited by the chlorine ions. Thus, even if the chlorine ions exist, vinylene carbonate is able to improve chemical stability of the electrolytic solution not depending on the content of the chlorine ions. Meanwhile, the chemical stabilization function of the sulfonic acid anhydride is inhibited by the chlorine ions. Thus, if the chlorine ions exist, the sulfonic acid anhydride is not able to improve chemical stability of the electrolytic solution in the case where the content of the chlorine ions is not sufficiently small. Thus, in the case where the sulfonic acid anhydride coexists with the chlorine ions, as described above, the content of the sulfonic acid anhydride should be kept to 5000 wt ppm or less.

Specially, the content of the chlorine ions is more preferably 100 wt ppm or less (from 0 wt ppm to 100 wt ppm both inclusive), is much more preferably 50 wt ppm or less (from 0 wt ppm to 50 wt ppm both inclusive), and is, in particular, preferably 30 wt ppm or less (from 0 wt ppm to 30 wt ppm both inclusive), since thereby the chemical stability of the electrolytic solution is more improved.

The chlorine ions contained in the electrolytic solution may be mixed in, for example, in the course of synthesizing the sulfonic acid anhydride, may be originally contained in the nonaqueous solvent or the electrolyte salt, or may exist in the electrolytic solution as a result of generation due to decomposition reaction or the like of the nonaqueous solvent or the electrolyte salt at the time of charge and discharge. In the case where the chlorine ions contained in the electrolytic solution are derived from the course of synthesizing the sulfonic acid anhydride, for example, the chlorine ions are generated from, for example, thionyl chloride (SOCl₂) used for initiating dehydration and condensation reaction. In the case where the chlorine ions contained in the electrolytic solution are derived from the nonaqueous solvent or the electrolyte salt, for example, since the nonaqueous solvent or the electrolyte salt has chlorine as an element, the chlorine ions are generated from the nonaqueous solvent or the electrolyte salt. However, the chlorine ions may exist in the electrolytic solution for a reason other than the foregoing reasons. Regarding the content of the chlorine ions, for example, if ion chromatography method or the like is used, the chlorine ions are able to be separated and the content thereof is able to be measured.

Other Nonaqueous Solvent

The nonaqueous solvent may contain one or more types of the after-mentioned organic solvents together with the sulfonic acid anhydride. The foregoing sulfonic acid anhydride will be eliminated from the after-mentioned nonaqueous solvents.

Examples of the organic solvents include the following compounds. That is, examples thereof include ethylene carbonate, propylene carbonate, butylene carbonate, dimethyl carbonate, diethyl carbonate, ethyl methyl carbonate, methylpropyl carbonate, γ-butyrolactone, γ-valerolactone, 1,2-dimethoxyethane, and tetrahydrofuran. Further examples thereof include 2-methyltetrahydrofuran, tetrahydropyran, 1,3-dioxolane, 4-methyl-1,3-dioxolane, 1,3-dioxane, and 1,4-dioxane. Furthermore, examples thereof include methyl acetate, ethyl acetate, methyl propionate, ethyl propionate, methyl butyrate, methyl isobutyrate, trimethyl methyl acetate, and trimethyl ethyl acetate. Furthermore, examples thereof include acetonitrile, glutaronitrile, adiponitrile, methoxyacetonitrile, 3-methoxypropionitrile, N,N-dimethylformamide, N-methylpyrrolidinone, and N-methyloxazolidinone. Furthermore, examples thereof include N,N′-dimethylimidazolidinone, nitromethane, nitroethane, sulfolane, trimethyl phosphate, and dimethyl sulfoxide. By using such a compound, superior battery capacity, superior cycle characteristics, superior storage characteristics and the like are able to be obtained in the secondary battery using the electrolytic solution.

Specially, at least one of ethylene carbonate, propylene carbonate, dimethyl carbonate, diethyl carbonate, and ethyl methyl carbonate is preferable, since thereby superior characteristics are able to be obtained. In this case, a combination of a high-viscosity (high dielectric constant) solvent (for example, specific inductive ε≧30) such as ethylene carbonate and propylene carbonate and a low-viscosity solvent (for example, viscosity≦1 mPa·s) such as dimethyl carbonate, ethylmethyl carbonate, and diethyl carbonate is more preferable. Thereby, dissociation property of the electrolyte salt and ion mobility are improved.

In particular, the organic solvent may be at least one of the unsaturated carbon bond cyclic ester carbonates expressed by Formula 3 to Formula 5. Thereby, a stable protective film is formed on the surface of the electrode at the time of charge and discharge, and thus decomposition reaction of the electrolytic solution is more inhibited. The “unsaturated carbon bond cyclic ester carbonate” is a cyclic ester carbonate having one or more unsaturated carbon bonds. R11 and R12 may be the same type of group, or may be a group different from each other. The same is applicable to R13 to R16. The content of the unsaturated carbon bond cyclic ester carbonate in the nonaqueous solvent is from, for example, 0.01 wt % to 10 wt % both inclusive, since thereby decomposition reaction of the electrolytic solution is inhibited while battery capacity is not excessively lowered. However, the unsaturated carbon bond cyclic ester carbonate is not limited to the compounds specifically described below.

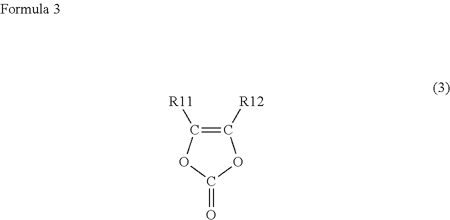

In the formula, R11 and R12 are a hydrogen group or an alkyl group.

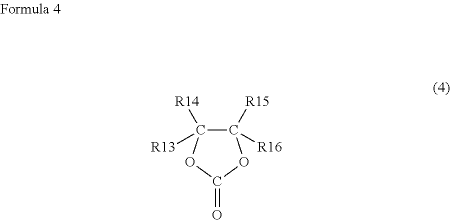

In the formula, R13 to R16 are a hydrogen group, an alkyl group, a vinyl group, or an aryl group. At least one of R13 to R16 is the vinyl group or the aryl group.

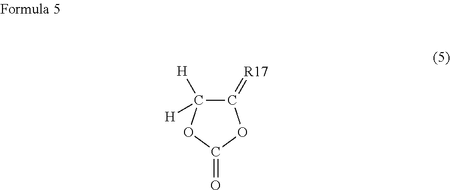

In the formula, R17 is an alkylene group.

The unsaturated carbon bond cyclic ester carbonate shown in Formula 3 is a vinylene carbonate compound. Examples of vinylene carbonate compounds include vinylene carbonate, methylvinylene carbonate, and ethylvinylene carbonate. The unsaturated carbon bond cyclic ester carbonate shown in Formula 4 is a vinylethylene carbonate compound. Examples of the vinylethylene carbonate compounds include vinylethylene carbonate. All of R13 to R16 may be the vinyl group or the aryl group. Otherwise, it is possible that some of R13 to R16 are the vinyl group, and the others thereof are the aryl group. The unsaturated carbon bond cyclic ester carbonate shown in Formula 5 is a methylene ethylene carbonate compound. Examples of the methylene ethylene carbonate compounds include 4-methylene-1,3-dioxolane-2-one. The methylene ethylene carbonate compound may have one methylene group, or may have two methylene groups. The unsaturated carbon bond cyclic ester carbonate may be catechol carbonate having a benzene ring or the like, in addition to the compounds shown in Formula 3 to Formula 5.

Further, the organic solvent may be at least one of halogenated chain ester carbonates expressed by Formula 6 and halogenated cyclic ester carbonates expressed by Formula 7. Thereby, a stable protective film is formed on the surface of the electrode at the time of charge and discharge, and thus decomposition reaction of the electrolytic solution is more inhibited. The halogenated chain ester carbonate is a chain ester carbonate having one or more halogens as an element. The halogenated cyclic ester carbonate is a cyclic ester carbonate having one or more halogens as an element. R21 to R26 may be the same type of group, or may be a group different from each other. The same is applicable to R27 to R30. The content of the halogenated chain ester carbonate and the content of the halogenated cyclic ester carbonate in the nonaqueous solvent are, for example, from 0.01 wt % to 50 wt % both inclusive, since thereby decomposition reaction of the electrolytic solution is inhibited while battery capacity is not excessively lowered. However, the halogenated chain ester carbonate or the halogenated cyclic ester carbonate is not limited to the compounds specifically described below.

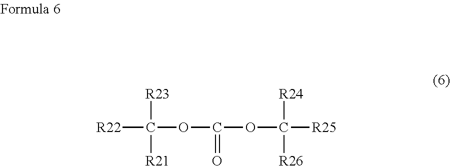

In the formula, R21 to R26 are a hydrogen group, a halogen group, an alkyl group, or a halogenated alkyl group. At least one of R21 to R26 is the halogen group or the halogenated alkyl group.

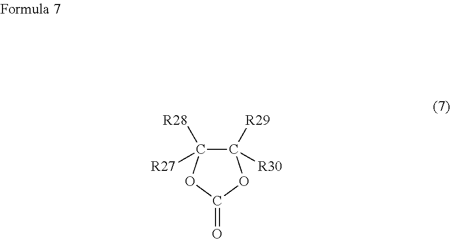

In the formula, R27 to R30 are a hydrogen group, a halogen group, an alkyl group, or a halogenated alkyl group. At least one of R27 to R30 is the halogen group or the halogenated alkyl group.

Though the halogen type is not particularly limited, specially, fluorine, chlorine, or bromine is preferable, and fluorine is more preferable since thereby higher effect is obtained compared to other halogen. The number of halogen is more preferably two than one, and further may be three or more, since thereby a more rigid and stable protective film is formed. Accordingly, decomposition reaction of the electrolytic solution is more inhibited.

Examples of the halogenated chain ester carbonate include fluoromethyl methyl carbonate, bis(fluoromethyl)carbonate, and difluoromethyl methyl carbonate. Examples of the halogenated cyclic ester carbonate include the compounds expressed by Formula (7-1) to Formula (7-21). The halogenated cyclic ester carbonate includes a geometric isomer. Specially, 4-fluoro-1,3-dioxolane-2-one shown in Formula (7-1) or 4,5-difluoro-1,3-dioxolane-2-one shown in Formula (7-3) is preferable, and the latter is more preferable. In particular, as 4,5-difluoro-1,3-dioxolane-2-one, a trans isomer is more preferable than a cis isomer.

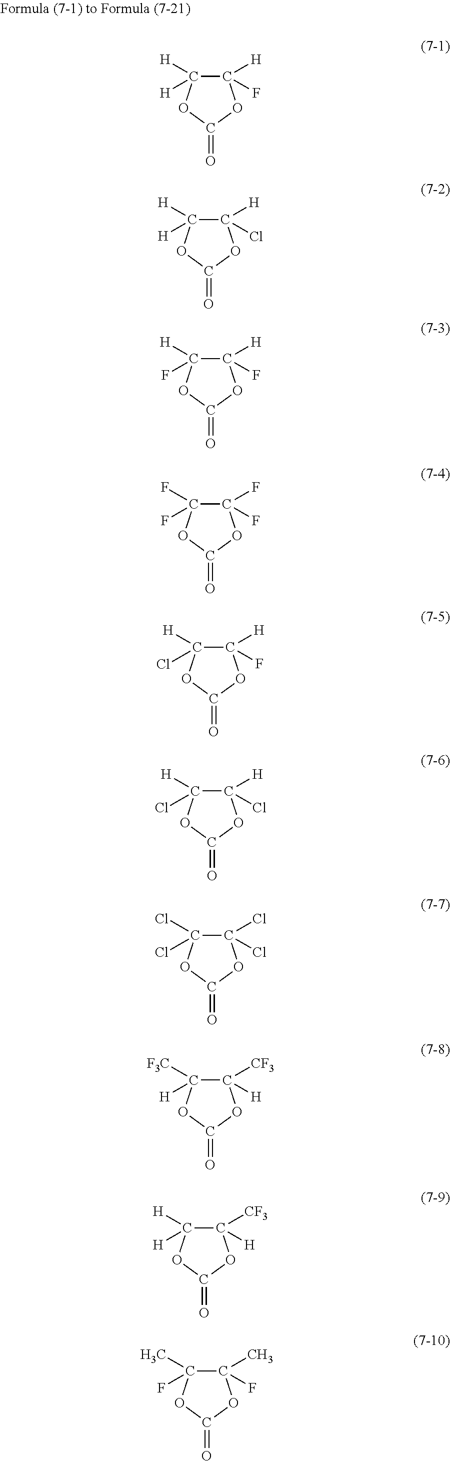

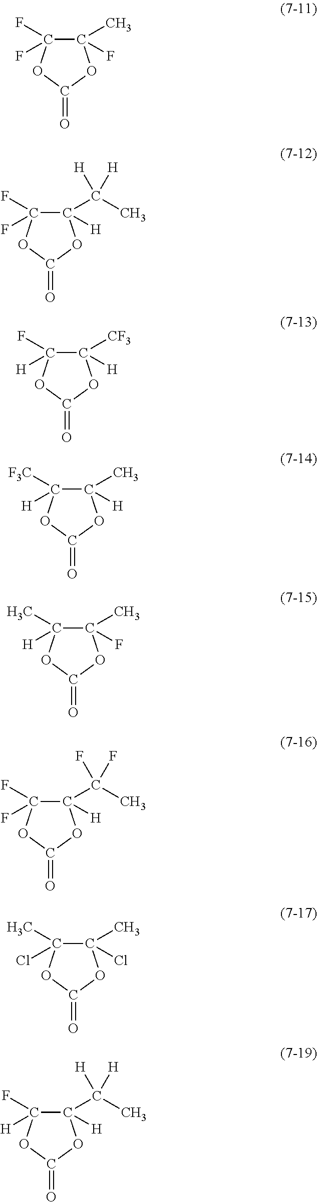

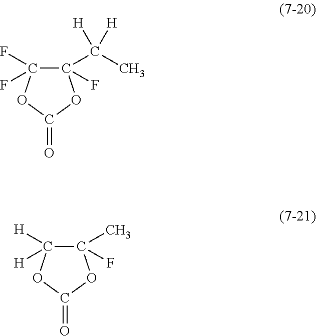

Further, the organic solvent may be sultone (cyclic sulfonic ester), since thereby the chemical stability of the electrolytic solution is more improved. Examples of the sultone include propane sultone and propene sultone, but the sultone is not limited thereto. The sultone content in the nonaqueous solvent is, for example, from 0.5 wt % to 5 wt % both inclusive, since thereby decomposition reaction of the electrolytic solution is inhibited while battery capacity is not excessively lowered.

Further, the organic solvent may be an acid anhydride, since the chemical stability of the electrolytic solution is thereby further improved. Examples of the acid anhydrides include a carboxylic anhydride such as succinic anhydride, glutaric anhydride, and maleic anhydride, but the acid anhydride is not limited thereto. The content of the acid anhydride in the nonaqueous solvent is from 0.5 wt % to 5 wt % both inclusive since thereby decomposition reaction of the electrolytic solution is inhibited while battery capacity is not excessively lowered.

Electrolyte Salt

The electrolyte salt contains, for example, one or more of lithium salts described below. However, the electrolyte salt may contain, for example, salts other than the lithium salt (for example, a light metal salt other than the lithium salt).

Examples of lithium salts include lithium hexafluorophosphate (LiPF₆), lithium tetrafluoroborate (LiBF₄), lithium perchlorate (LiClO₄), lithium hexafluoroarsenate (LiAsF₆), lithium tetraphenylborate (LiB(C₆H₅)₄), lithium methanesulfonate (LiCH₃SO₃), lithium trifluoromethane sulfonate (LiCF₃SO₃), lithium tetrachloroaluminate (LiAlCl₄), dilithium hexafluorosilicate (Li₂SiF₆), lithium chloride (LiCl), and lithium bromide (LiBr). Thereby, superior battery capacity, superior cycle characteristics, superior storage characteristics and the like are obtained in the secondary battery using the electrolytic solution.

Specially, at least one of lithium hexafluorophosphate, lithium tetrafluoroborate, lithium perchlorate, and lithium hexafluoroarsenate is preferable, and lithium hexafluorophosphate is more preferable, since thereby internal resistance is lowered, and higher effect is able to be obtained.

In particular, the electrolyte salt may be at least one of compounds expressed by Formula 8 to Formula 10, since thereby higher effect is obtained. R31 and R33 may be the same type of group, or may be a group different from each other. The same is applicable to R41 to R43, R51, and R52. However, the compounds shown in Formula 8 to Formula 10 are not limited to compounds specifically described below.

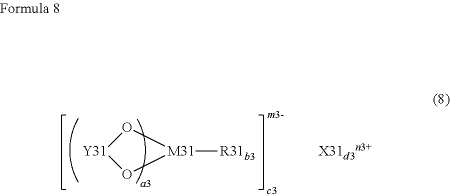

In the formula, X31 is a Group 1 element or a Group 2 element in the long period periodic table or aluminum. M31 is a transition metal, a Group 13 element, a Group 14 element, or a Group 15 element in the long period periodic table. R31 is a halogen group. Y31 is —C(═O)—R32-C(═O)—, —C(═O)—CR33₂-, or —C(═O)—C(═O)—. R32 is an alkylene group, a halogenated alkylene group, an arylene group, or a halogenated arylene group. R33 is an alkyl group, a halogenated alkyl group, an aryl group, or a halogenated aryl group. a3 is one of integer numbers 1 to 4. b3 is one of integer numbers 0, 2, and 4. c3, d3, m3, and n3 are one of integer numbers 1 to 3.

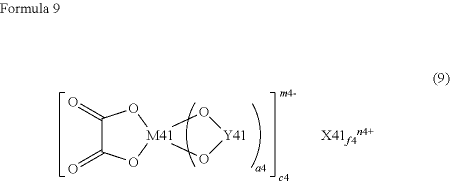

In the formula, X41 is a Group 1 element or a Group 2 element in the long period periodic table. M41 is a transition metal element or a Group 13 element, a Group 14 element, or a Group 15 element in the long period periodic table. Y41 is —C(═O)—(CR41₂)_{b4}-C(═O)—, —R43₂C—(CR42₂)_{c4}—C(═O)—, —R43₂C—(CR42₂)_{c4}—CR43₂-, —R43₂C—(CR42₂)_{c4}-S(═O)₂—, —S(═O)₂—(CR42₂)_{d4}-S(═O)₂—, or —C(═O)—(CR42₂)_{d4}-S(═O)₂—. R41 and R43 are a hydrogen group, an alkyl group, a halogen group, or a halogenated alkyl group. At least one of R41 and R43 is respectively the halogen group or the halogenated alkyl group. R42 is a hydrogen group, an alkyl group, a halogen group, or a halogenated alkyl group. a4, e4, and n4 are an integer number 1 or 2. b4 and d4 are one of integer numbers 1 to 4. c4 is one of integer numbers 0 to 4. f4 and m4 are one of integer numbers 1 to 3.

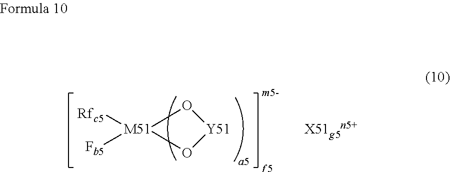

In the formula, X51 is a Group 1 element or a Group 2 element in the long period periodic table. M51 is a transition metal or a Group 13 element, a Group 14 element, or a Group 15 element in the long period periodic table. Rf is a fluorinated alkyl group with the carbon number from 1 to 10 both inclusive or a fluorinated aryl group with the carbon number from 1 to 10 both inclusive. Y51 is —C(═O)—(CR51₂)_{d5}-C(═O)—, —R52₂C—(CR51₂)_{d5}-C(═O)—, —R52₂C—(CR51₂)_{d5}-CR52₂-, —R52₂C—(CR51₂)_{d5}-S(═O)₂—, —S(═O)₂—(CR51₂)ₑ₅-S(═O)₂—, or —C(═O)—(CR51₂)ₑ₅-S(═O)₂—. R51 is a hydrogen group, an alkyl group, a halogen group, or a halogenated alkyl group. R52 is a hydrogen group, an alkyl group, a halogen group, or a halogenated alkyl group, and at least one thereof is the halogen group or the halogenated alkyl group. a5, f5, and n5 are integer number 1 or 2. b5, c5, and e5 are one of integer numbers 1 to 4. d5 is one of integer numbers 0 to 4. g5 and m5 are one of integer numbers 1 to 3.

Group 1 element represents hydrogen, lithium, sodium, potassium, rubidium, cesium, and francium. Group 2 element represents beryllium, magnesium, calcium, strontium, barium, and radium. Group 13 element represents boron, aluminum, gallium, indium, and thallium. Group 14 element represents carbon, silicon, germanium, tin, and lead. Group 15 element represents nitrogen, phosphorus, arsenic, antimony, and bismuth.

Examples of the compound shown in Formula 8 include at least one of compounds expressed by Formula (8-1) to Formula (8-6). Examples of the compound shown in Formula 9 include at least one of compounds expressed by Formula (9-1) to Formula (9-8). Examples of the compound shown in Formula 10 include a compound expressed by Formula (10-1).

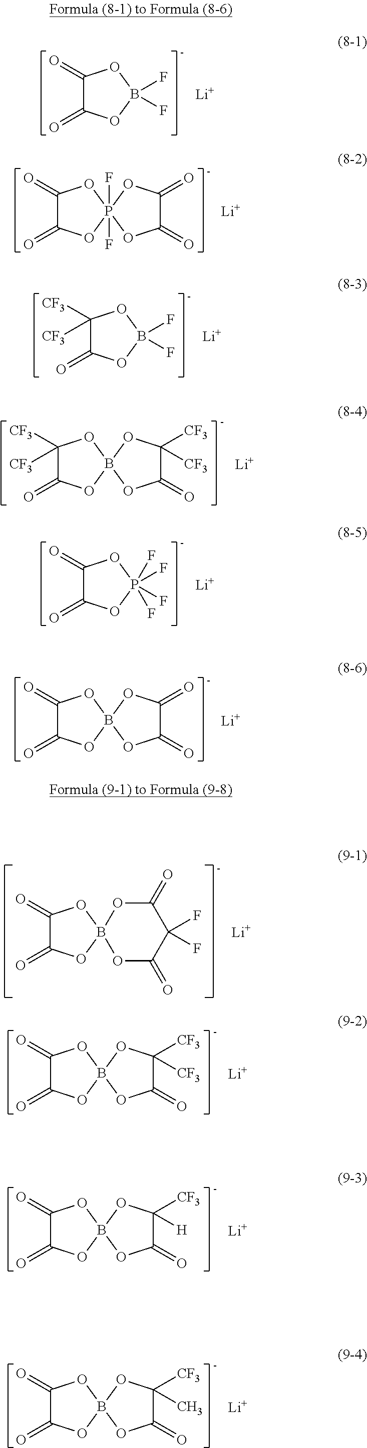

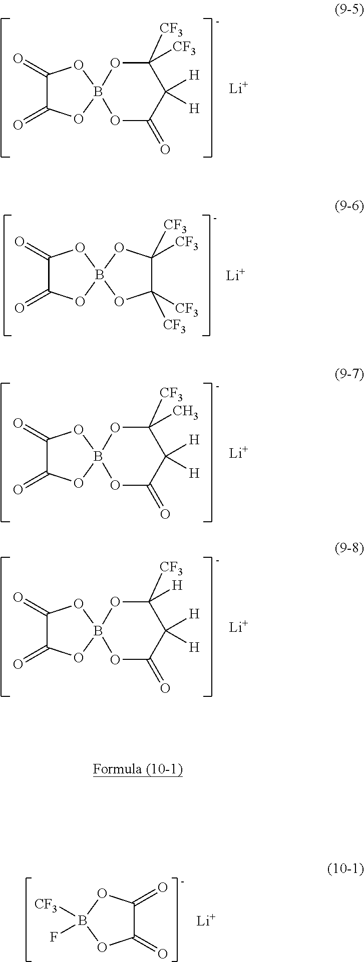

Further, the electrolyte salt may be at least one of the compounds expressed by Formula 11 to Formula 13, since thereby higher effect is obtained. m and n may be the same value or a value different from each other. The same is applicable to p, q, and r. The compounds shown in Formula 11 to Formula 13 are not limited to compounds specifically described below.

Formula 11

LiN(CₘF₂ₘ₊₁SO₂)(CₙF₂ₙ₊₁SO₂) (11)

In the formula, m and n are an integer number greater than 1 or equal to 1.

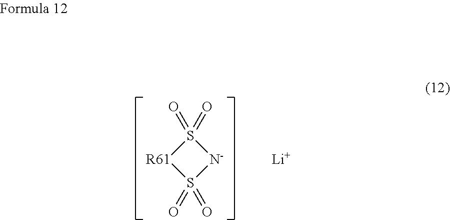

In the formula, R61 is a straight chain or branched perfluoro alkylene group with the carbon number from 2 to 4 both inclusive.

Formula 13

LiC(CₚF₂ₚ₊₁SO₂)(C_{q}F_{2q+1}SO₂)(CᵣF₂ᵣ₊₁SO₂) (13)

In the formula, p, q, and r are an integer number greater than 1 or equal to 1.

The compound shown in Formula 11 is a chain imide compound. Examples of the chain imide compound include lithium bis(trifluoromethanesulfonyl)imide (LiN(CF₃SO₂)₂) and lithium bis(pentafluoroethanesulfonyl)imide (LiN(C₂F₅SO₂)₂). The compound shown in Formula 12 is a cyclic imide compound. Examples of the cyclic imide compound include at least one of the compounds expressed by Formula (12-1) to Formula (12-4). The compound shown in Formula 13 is a chain methyde compound. Examples of the chain methyde compound include lithium tris(trifluoromethanesulfonyl)methyde (LiC(CF₃SO₂)₃).

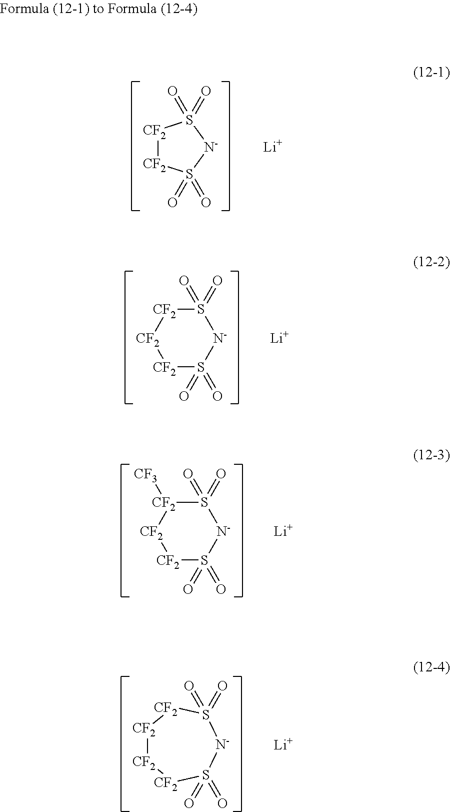

The content of the electrolyte salt is preferably from 0.3 mol/kg to 3.0 mol/kg both inclusive with respect to the nonaqueous solvent, since thereby high ion conductivity is obtained.

Action and Effect of Electrolytic Solution for a Secondary Battery

The electrolytic solution for a secondary battery contains the sulfonic acid anhydride and the chlorine ions, and the content of the chlorine ions is 5000 wt ppm or less. Thereby, even if the sulfonic acid anhydride coexists with the chlorine ions, the chemical stabilization function of the sulfonic acid anhydride is retained, and thus decomposition reaction of the electrolytic solution is inhibited at the time of charge and discharge. In the result, the secondary battery using the electrolytic solution is able to be thereby improved. In this case, in the case where the content of the chlorine ions is 50 wt ppm or less, higher effect is able to be obtained.

2. Secondary Battery

Next, a description will be given of application examples of the foregoing electrolytic solution. The electrolytic solution is used for a secondary battery as follows.

2-1. Lithium Ion Secondary Battery (Cylindrical Type)

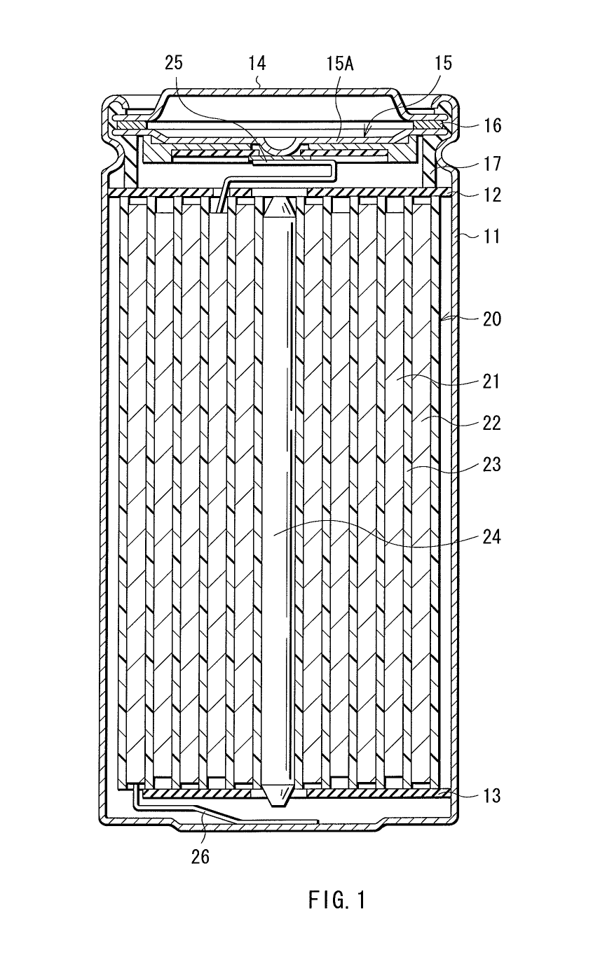

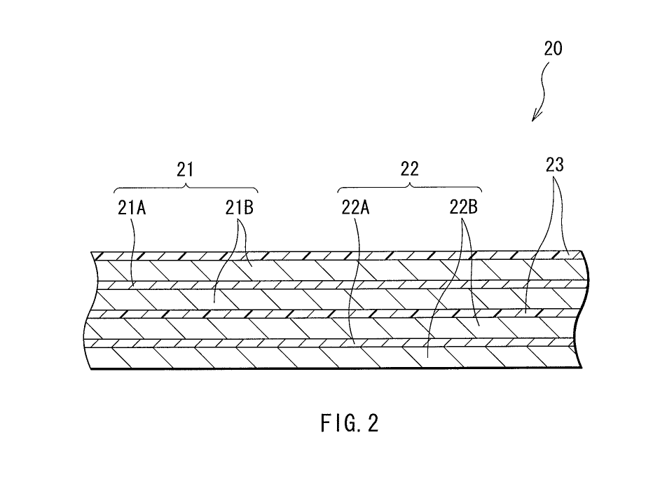

FIG. 1 and FIG. 2 illustrate a cross sectional structure of a lithium ion secondary battery (cylindrical type) as an example of secondary batteries. FIG. 2 illustrates an enlarged part of a spirally wound electrode body 20 illustrated in FIG. 1. In the secondary battery, the anode capacity is expressed by insertion and extraction of lithium ion.

Whole Structure of the Secondary Battery

The secondary battery mainly contains the spirally wound electrode body 20 and a pair of insulating plates 12 and 13 inside a battery can 11 in the shape of an approximately hollow cylinder. The spirally wound electrode body 20 is a spirally wound laminated body in which a cathode 21 and an anode 22 are layered with a separator 23 in between and are spirally wound.

The battery can 11 has a hollow structure in which one end of the battery can 11 is closed and the other end of the battery can 11 is opened. The battery can 11 is made of, for example, iron, aluminum, an alloy thereof or the like. In the case where the battery can 11 is made of iron, for example, plating of nickel or the like may be provided on the surface of the battery can 11. The pair of insulating plates 12 and 13 is arranged to sandwich the spirally wound electrode body 20 in between from the upper and the lower sides, and to extend perpendicularly to the spirally wound periphery face.

At the open end of the battery can 11, a battery cover 14, a safety valve mechanism 15, and a PTC (Positive Temperature Coefficient) device 16 are attached by being caulked with a gasket 17. Inside of the battery can 11 is hermetically sealed. The battery cover 14 is made of, for example, a material similar to that of the battery can 11. The safety valve mechanism 15 and the PTC device 16 are provided inside the battery cover 14. The safety valve mechanism 15 is electrically connected to the battery cover 14 through the PTC device 16. In the safety valve mechanism 15, in the case where the internal pressure becomes a certain level or more by internal short circuit, external heating or the like, a disk plate 15A flips to cut the electric connection between the battery cover 14 and the spirally wound electrode body 20. As temperature rises, the PTC device 16 increases the resistance and thereby abnormal heat generation resulting from a large current is prevented. The gasket 17 is made of, for example, an insulating material. The surface of the gasket 17 may be coated with, for example, asphalt.

In the center of the spirally wound electrode body 20, a center pin 24 may be inserted. A cathode lead 25 made of a conductive material such as aluminum is connected to the cathode 21, and an anode lead 26 made of a conductive material such as nickel is connected to the anode 22. The cathode lead 25 is electrically connected to the battery cover 14 by, for example, being welded to the safety valve mechanism 15. The anode lead 26 is, for example, welded and thereby electrically connected to the battery can 11.

Cathode

In the cathode 21, for example, a cathode active material layer 21B is provided on a single face or both faces of a cathode current collector 21A.

The cathode current collector 21A is made of, for example, a conductive material such as aluminum (Al), nickel (Ni), and stainless steel.

The cathode active material layer 21B contains, as a cathode active material, one or more cathode materials capable of inserting and extracting lithium ions. According to needs, the cathode active material layer 21B may contain other material such as a cathode binder and a cathode conductive agent.

As the cathode material, a lithium-containing compound is preferable, since thereby a high energy density is able to be obtained. Examples of the lithium-containing compounds include a composite oxide having lithium and a transition metal element as an element and a phosphate compound containing lithium and a transition metal element as an element. Specially, a compound containing one or more of cobalt (Co), nickel, manganese (Mn), and iron (Fe) as a transition metal element is preferable, since thereby a higher voltage is obtained. The chemical formula thereof is expressed by, for example, LiₓM1O₂ or Li_{y}M2PO₄. In the formula, M1 and M2 represent one or more transition metal elements. Values of x and y vary according to the charge and discharge state, and are generally in the range of 0.05≦x≦1.10 and 0.05≦y≦1.10.

Examples of composite oxides having lithium and a transition metal element include a lithium-cobalt composite oxide (LiₓCoO₂), a lithium-nickel composite oxide (LiₓNiO₂), and a lithium-nickel composite oxide expressed by the following Chemical formula. Examples of phosphate compounds having lithium and a transition metal element include lithium-iron phosphate compound (LiFePO₄) and a lithium-iron-manganese phosphate compound (LiFe₁₋ᵤMnᵤPO₄ (u<1)), since thereby a high battery capacity is obtained and superior cycle characteristics are obtained.

LiNi₁₋ₓMₓO₂

In the formula, M is one or more of cobalt, manganese, iron, aluminum, vanadium, tin, magnesium, titanium, strontium, calcium, zirconium, molybdenum, technetium, ruthenium, tantalum, tungsten, rhenium, ytterbium, copper, zinc, barium, boron, chromium, silicon, gallium, phosphorus, antimony, and niobium. x is in the range of 0.005<x<0.5.

In addition, examples of cathode materials include an oxide, a disulfide, a chalcogenide, and a conductive polymer. Examples of oxides include titanium oxide, vanadium oxide, and manganese dioxide. Examples of disulfide include titanium disulfide and molybdenum sulfide. Examples of chalcogenide include niobium selenide. Examples of conductive polymer include sulfur, polyaniline, and polythiophene.

Examples of cathode binders include one or more of a synthetic rubber and a polymer material. Examples of the synthetic rubber include styrene butadiene rubber, fluorinated rubber, and ethylene propylene diene. Examples of the polymer material include polyvinylidene fluoride and polyimide.

Examples of cathode conductive agents include one or more carbon materials and the like. Examples of the carbon materials include graphite, carbon black, acetylene black, and Ketjen black. The cathode conductive agent may be a metal material, a conductive polymer or the like as long as the material has the electric conductivity.

### [Anode]

In the anode 22, for example, an anode active material layer 22B is provided on a single face or both faces of an anode current collector 22A.

The anode current collector 22A is made of, for example, a conductive material such as copper, nickel, and stainless steel. The surface of the anode current collector 22A is preferably roughened. Thereby, due to the so-called anchor effect, the contact characteristics between the anode current collector 22A and the anode active material layer 22B are improved. In this case, it is enough that at least the surface of the anode current collector 22A in the area opposed to the anode active material layer 22B is roughened. Examples of roughening methods include a method of forming fine particles by electrolytic treatment. The electrolytic treatment is a method of providing concavity and convexity by forming fine particles on the surface of the anode current collector 22A by electrolytic method in an electrolytic bath. A copper foil formed by electrolytic method is generally called “electrolytic copper foil.”

The anode active material layer 22B contains one or more anode materials capable of inserting and extracting lithium ions as an anode active material, and may also contain other material such as an anode binder and an anode conductive agent according to needs. Details of the anode binder and the anode conductive agent are, for example, respectively similar to those of the cathode binder and the cathode conductive agent. In the anode active material layer 22B, for example, the chargeable capacity of the anode material is preferably larger than the discharge capacity of the cathode 21 in order to prevent unintentional precipitation of lithium metal at the time of charge and discharge.

Examples of anode materials include a carbon material. In the carbon material, crystal structure change at the time of insertion and extraction of lithium ions is extremely small. Thus, the carbon material provides a high energy density and superior cycle characteristics, and functions as an anode conductive agent as well. Examples of carbon materials include graphitizable carbon, non-graphitizable carbon in which the spacing of (002) plane is 0.37 nm or more, and graphite in which the spacing of (002) plane is 0.34 nm or less. More specifically, examples of carbon materials include pyrolytic carbon, coke, glassy carbon fiber, an organic polymer compound fired body, activated carbon, and carbon black. Of the foregoing, the coke includes pitch coke, needle coke, and petroleum coke. The organic polymer compound fired body is obtained by firing and carbonizing a phenol resin, a furan resin or the like at an appropriate temperature. The shape of the carbon material may be any of a fibrous shape, a spherical shape, a granular shape, and a scale-like shape.

Examples of anode materials include a material (metal material) having one or more of metal elements and metalloid elements as an element. Such a metal material is preferably used, since a high energy density is able to be thereby obtained. Such a metal material may be a simple substance, an alloy, or a compound of a metal element or a metalloid element, may be two or more thereof, or may have one or more phases thereof at least in part. In the present disclosure, “alloy” includes a material containing one or more metal elements and one or more metalloid elements, in addition to a material composed of two or more metal elements. Further, “alloy” may contain a nonmetallic element. The texture thereof includes a solid solution, a eutectic crystal (eutectic mixture), an intermetallic compound, and a texture in which two or more thereof coexist.

The foregoing metal element or the foregoing metalloid element is a metal element or a metalloid element capable of forming an alloy with lithium. Specifically, the foregoing metal element or the foregoing metalloid element is one or more of the following elements. That is, the foregoing metal element or the foregoing metalloid element is one or more of magnesium (Mg), boron (B), aluminum, gallium (Ga), indium (In), silicon (Si), germanium (Ge), tin (Sn), lead (Pb), bismuth (Bi), cadmium (Cd), silver (Ag), zinc (Zn), hafnium (Hf), zirconium (Zr), yttrium (Y), palladium (Pd), and platinum (Pt). Specially, at least one of silicon and tin is preferably used. Silicon and tin have the high ability to insert and extract lithium ion, and thus are able to provide a high energy density.

A material having at least one of silicon and tin may be, for example, a simple substance, an alloy, or a compound of silicon or tin; two or more thereof; or a material having one or more phases thereof at least in part.

Examples of alloys of silicon include a material having one or more of the following elements as an element other than silicon. Such an element other than silicon is tin, nickel, copper, iron, cobalt, manganese, zinc, indium, silver, titanium, germanium, bismuth, antimony, and chromium. Examples of compounds of silicon include a compound having oxygen or carbon as an element other than silicon. The compounds of silicon may have one or more of the elements described for the alloys of silicon as an element other than silicon.

Examples of an alloy or a compound of silicon include SiB₄, SiB₆, Mg₂Si, Ni₂Si, TiSi₂, MoSi₂, CoSi₂, NiSi₂, CaSi₂, CrSi₂, Cu₅Si, FeSi₂, MnSi₂, NbSi₂, TaSi₂, VSi₂, WSi₂, ZnSi₂, SiC, Si₃N₄, Si₂N₂O, SiOᵥ (0<v≦2), and LiSiO.

Examples of alloys of tin include a material having one or more of the following elements as an element other than tin. Such an element is silicon, nickel, copper, iron, cobalt, manganese, zinc, indium, silver, titanium, germanium, bismuth, antimony, or chromium. Examples of compounds of tin include a material having oxygen or carbon as an element. The compounds of tin may have one or more elements described for the alloys of tin as an element other than tin. Examples of alloys or compounds of tin include SnO_{w} (0<w≦2), SnSiO₃, LiSnO, and Mg₂Sn.

In particular, as a material having silicon, for example, the simple substance of silicon is preferable, since a high battery capacity, superior cycle characteristics and the like are thereby obtained. “Simple substance” only means a general simple substance (may contain a slight amount of impurity), but does not necessarily mean a substance with purity 100%.

Further, as a material having tin, for example, a material containing a second element and a third element in addition to tin as a first element is preferable. The second element is, for example, one or more of the following elements. That is, the second element is one or more of cobalt, iron, magnesium, titanium, vanadium, chromium, manganese, nickel, copper, zinc, gallium, zirconium, niobium, molybdenum, silver, indium, cerium (Ce), hafnium, tantalum, tungsten (W), bismuth, and silicon. The third element is, for example, one or more of boron, carbon, aluminum, and phosphorus. In the case where the second element and the third element are contained, a high battery capacity, superior cycle characteristics and the like are obtained.

Specially, a material having tin, cobalt, and carbon (SnCoC-containing material) is preferable. As the composition of the SnCoC-containing material, for example, the carbon content is from 9.9 mass % to 29.7 mass % both inclusive, and the ratio of tin and cobalt contents (Co/(Sn+Co)) is from 20 mass % to 70 mass % both inclusive, since a high energy density is obtained in such a composition range.

It is preferable that the SnCoC-containing material has a phase containing tin, cobalt, and carbon. Such a phase preferably has a low crystalline structure or an amorphous structure. The phase is a reaction phase capable of being reacted with lithium. Due to existence of the reaction phase, superior characteristics are able to be obtained. The half-width of the diffraction peak obtained by X-ray diffraction of the phase is preferably 1.0 deg or more based on diffraction angle of 2θ in the case where CuKα ray is used as a specific X ray, and the trace speed is 1 deg/min. Thereby, lithium ions are more smoothly inserted and extracted, and reactivity with the electrolytic solution is decreased. In some cases, the SnCoC-containing material has a phase containing a simple substance or part of the respective elements in addition to the low crystalline or amorphous phase.

Whether or not the diffraction peak obtained by X-ray diffraction corresponds to the reaction phase capable of being reacted with lithium is able to be easily determined by comparison between X-ray diffraction charts before and after electrochemical reaction with lithium. For example, if the position of the diffraction peak after electrochemical reaction with lithium is changed from the position of the diffraction peak before electrochemical reaction with lithium, the obtained diffraction peak corresponds to the reaction phase capable of being reacted with lithium. In this case, for example, the diffraction peak of the low crystalline or amorphous reaction phase is shown in the range of 2θ=from 20 to 50 deg both inclusive. Such a reaction phase has, for example, the foregoing respective elements, and the low crystalline or amorphous structure may result from existence of carbon.

In the SnCoC-containing material, at least part of carbon as an element is preferably bonded to a metal element or a metalloid element as other element, since thereby cohesion or crystallization of tin or the like is inhibited. The bonding state of elements is able to be checked by, for example, X-ray Photoelectron Spectroscopy (XPS). In a commercially available apparatus, for example, as a soft X ray, Al—Kα ray, Mg—Kα ray or the like is used. In the case where at least part of carbon is bonded to a metal element, a metalloid element or the like, the peak of a synthetic wave of 1s orbit of carbon (C1s) is shown in a region lower than 284.5 eV. In the apparatus, energy calibration is made so that the peak of 4f orbit of gold atom (Au4f) is obtained at 84.0 eV. At this time, in general, since surface contamination carbon exists on the material surface, the peak of C1s of the surface contamination carbon is regarded as 284.8 eV, which is used as the energy reference. In XPS measurement, the waveform of the peak of C1s is obtained as a form including the peak of the surface contamination carbon and the peak of carbon in the SnCoC-containing material. Thus, for example, analysis is made by using commercially available software to isolate both peaks from each other. In the waveform analysis, the position of a main peak existing on the lowest bound energy is the energy reference (284.8 eV).

The SnCoC-containing material may further contain other element according to needs. Examples of other elements include one or more of silicon, iron, nickel, chromium, indium, niobium, germanium, titanium, molybdenum, aluminum, phosphorus, gallium, and bismuth.

In addition to the SnCoC-containing material, a material containing tin, cobalt, iron, and carbon (SnCoFeC-containing material) is also preferable. The composition of the SnCoFeC-containing material is able to be optionally set. For example, a composition in which the iron content is set small is as follows. That is, the carbon content is from 9.9 mass % to 29.7 mass % both inclusive, the iron content is from 0.3 mass % to 5.9 mass % both inclusive, and the ratio of contents of tin and cobalt (Co/(Sn+Co)) is from 30 mass % to 70 mass % both inclusive. Further, for example, a composition in which the iron content is set large is as follows. That is, the carbon content is from 11.9 mass % to 29.7 mass % both inclusive, the ratio of contents of tin, cobalt, and iron ((Co+Fe)/(Sn+Co+Fe)) is from 26.4 mass % to 48.5 mass % both inclusive, and the ratio of contents of cobalt and iron (Co/(Co+Fe)) is from 9.9 mass % to 79.5 mass % both inclusive. In such a composition range, a high energy density is obtained. The physical properties (half-width and the like) of the SnCoFeC-containing material are similar to those of the foregoing SnCoC-containing material.

Further, examples of other anode materials include a metal oxide and a polymer compound. The metal oxide is, for example, iron oxide, ruthenium oxide, molybdenum oxide or the like. The polymer compound is, for example, polyacetylene, polyaniline, polypyrrole or the like.

The anode active material layer 22B is formed by, for example, coating method, vapor-phase deposition method, liquid-phase deposition method, spraying method, firing method (sintering method), or a combination of two or more of these methods. Coating method is a method in which, for example, a particulate anode active material is mixed with a binder or the like, the mixture is dispersed in a solvent such as an organic solvent, and the anode current collector is coated with the resultant. Examples of vapor-phase deposition methods include physical deposition method and chemical deposition method. Specifically, examples thereof include vacuum evaporation method, sputtering method, ion plating method, laser ablation method, thermal Chemical Vapor Deposition method, Chemical Vapor Deposition (CVD) method, and plasma Chemical Vapor Deposition method. Examples of liquid-phase deposition methods include electrolytic plating method and electroless plating method. Spraying method is a method in which the anode active material is sprayed in a fused state or a semi-fused state. Firing method is, for example, a method in which after the anode current collector is coated by a procedure similar to that of coating method, heat treatment is provided at a temperature higher than the melting point of the binder or the like. Examples of firing methods include a known technique such as atmosphere firing method, reactive firing method, and hot press firing method.

Separator

The separator 23 separates the cathode 21 from the anode 22, and passes lithium ions while preventing current short circuit resulting from contact of both electrodes. The separator 23 is impregnated with the foregoing electrolytic solution for a secondary battery as a liquid electrolyte (electrolytic solution). The separator 23 is formed from, for example, a porous film made of a synthetic resin or ceramics. The separator 23 may be a laminated film composed of two or more porous films. Examples of synthetic resin include polytetrafluoroethylene, polypropylene, and polyethylene.

Operation of the Secondary Battery

In the secondary battery, at the time of charge, for example, lithium ions extracted from the cathode 21 are inserted in the anode 22 through the electrolytic solution. Further, at the time of discharge, for example, lithium ions extracted from the anode 22 are inserted in the cathode 21 through the electrolytic solution.

Method of Manufacturing the Secondary Battery

The secondary battery is manufactured, for example, by the following procedure.

First, the cathode 21 is formed. First, a cathode active material is mixed with a cathode binder, a cathode conductive agent or the like according to needs to prepare a cathode mixture, which is subsequently dispersed in a solvent such as an organic solvent to obtain paste cathode mixture slurry. Subsequently, both faces of the cathode current collector 21A are coated with the cathode mixture slurry, which is dried to form the cathode active material layer 21B. Finally, the cathode active material layer 21B is compression-molded by a rolling press machine or the like while being heated if necessary. In this case, the resultant may be compression-molded over several times.

Next, the anode 22 is formed by a procedure similar to that of the foregoing cathode 21. In this case, an anode active material is mixed with an anode binder, an anode conductive agent or the like according to needs to prepare an anode mixture, which is subsequently dispersed in a solvent to form paste anode mixture slurry. Subsequently, both faces of the anode current collector 22A are coated with the anode mixture slurry, which is dried to form the anode active material layer 22B. After that, the anode active material layer 22B is compression-molded according to needs.

The anode 22 may be formed by a procedure different from that of the cathode 21. In this case, for example, the anode material is deposited on both faces of the anode current collector 22A by vapor-phase deposition method such as evaporation method to form the anode active material layer 22B.

Finally, the secondary battery is assembled by using the cathode 21 and the anode 22. First, the cathode lead 25 is attached to the cathode current collector 21A by welding or the like, and the anode lead 26 is attached to the anode current collector 22A by welding or the like. Subsequently, the cathode 21 and the anode 22 are layered with the separator 23 in between and spirally wound, and thereby the spirally wound electrode body 20 is formed. After that, the center pin 24 is inserted in the center of the spirally wound electrode body 20. Subsequently, the spirally wound electrode body 20 is sandwiched between the pair of insulating plates 12 and 13, and contained in the battery can 11. In this case, the end of the cathode lead 25 is attached to the safety valve mechanism 15 by welding or the like, and the end of the anode lead 26 is attached to the battery can 11 by welding or the like. Subsequently, the electrolytic solution is injected into the battery can 11, and the separator 23 is impregnated with the electrolytic solution. Finally, at the open end of the battery can 11, the battery cover 14, the safety valve mechanism 15, and the PTC device 16 are fixed by being caulked with the gasket 17. The secondary battery illustrated in FIG. 1 and FIG. 2 is thereby completed.

Action and Effect of the Secondary Battery

Since the secondary battery includes the foregoing electrolytic solution for a secondary battery as an electrolytic solution, decomposition reaction of the electrolytic solution at the time of charge and discharge is inhibited. Therefore, battery characteristics such as cycle characteristics, storage characteristics, and voltage characteristics are able to be improved. In particular, in the case where the metal material advantageous to achive a high capacity as an anode active material of the anode 22 is used, the characteristics are improved. Thus, higher effect is able to be obtained than in a case that a carbon material or the like is used. Other action and effect for the secondary battery are similar to those of the electrolytic solution for a secondary battery.

2-2. Lithium Ion Secondary Battery (Laminated Film Type)

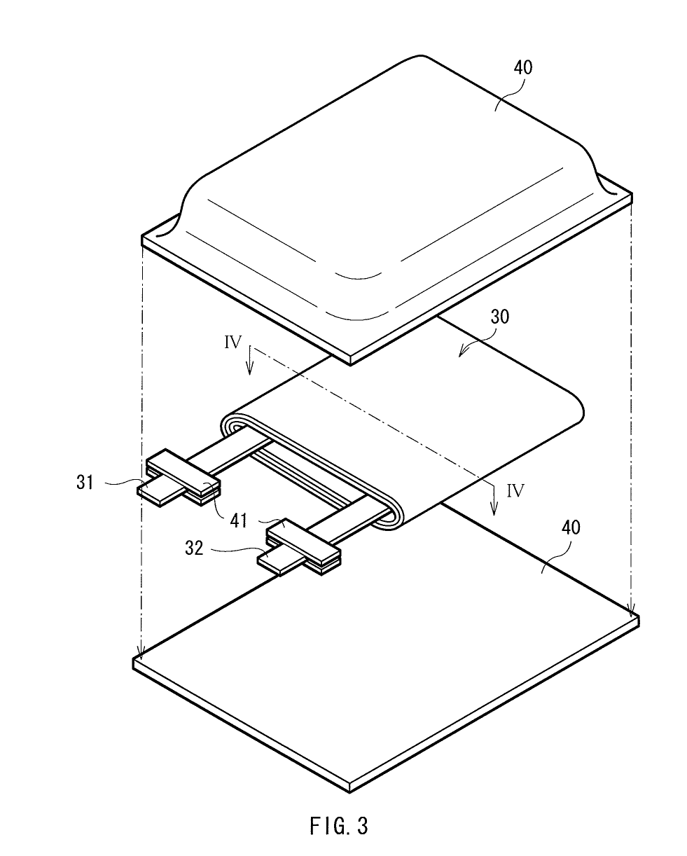

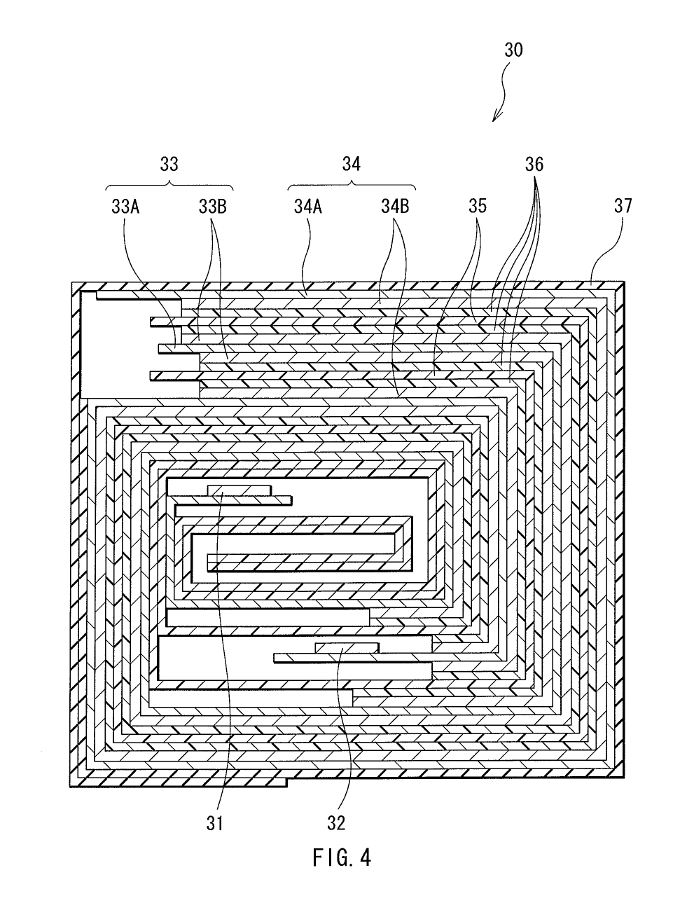

FIG. 3 illustrates an exploded perspective structure of a lithium ion secondary battery (laminated film type). FIG. 4 illustrates an enlarged cross section taken along line IV-IV of a spirally wound electrode body 30 illustrated in FIG. 3.

Whole Structure of the Secondary Battery

In the secondary battery, a spirally wound electrode body 30 is contained in a film package member 40 mainly. The spirally wound electrode body 30 is a spirally wound laminated body in which a cathode 33 and an anode 34 are layered with a separator 35 and an electrolyte layer 36 in between and are spirally wound. A cathode lead 31 is attached to the cathode 33, and an anode lead 32 is attached to the anode 34. The outermost peripheral section of the spirally wound electrode body 30 is protected by a protective tape 37.

The cathode lead 31 and the anode lead 32 are, for example, respectively led out from inside to outside of the package member 40 in the same direction. The cathode lead 31 is made of, for example, a conductive material such as aluminum, and the anode lead 32 is made of, for example, a conducive material such as copper, nickel, and stainless steel. These materials are in the shape of, for example, a thin plate or mesh.

The package member 40 is a laminated film in which, for example, a fusion bonding layer, a metal layer, and a surface protective layer are layered in this order. In the laminated film, for example, the respective outer edges of the fusion bonding layer of two films are bonded to each other by fusion bonding, an adhesive or the like so that the fusion bonding layer and the spirally wound electrode body 30 are opposed to each other. Examples of fusion bonding layers include a film made of polyethylene, polypropylene or the like. Examples of metal layers include an aluminum foil. Examples of surface protective layers include a film made of nylon, polyethylene terephthalate or the like.

Specially, as the package member 40, an aluminum laminated film in which a polyethylene film, an aluminum foil, and a nylon film are layered in this order is preferable. However, the package member 40 may be made of a laminated film having other laminated structure, a polymer film such as polypropylene, or a metal film.

An adhesive film 41 to protect from entering of outside air is inserted between the package member 40 and the cathode lead 31, the anode lead 32. The adhesive film 41 is made of a material having contact characteristics with respect to the cathode lead 31 and the anode lead 32. Examples of such a material include, for example, a polyolefin resin such as polyethylene, polypropylene, modified polyethylene, and modified polypropylene.

In the cathode 33, a cathode active material layer 33B is provided on both faces of a cathode current collector 33A. In the anode 34, for example, an anode active material layer 34B is provided on both faces of an anode current collector 34A. The structures of the cathode current collector 33A, the cathode active material layer 33B, the anode current collector 34A, and the anode active material layer 34B are respectively similar to the structures of the cathode current collector 21A, the cathode active material layer 21B, the anode current collector 22A, and the anode active material layer 22B. The structure of the separator 35 is similar to the structure of the separator 23.

In the electrolyte layer 36, an electrolytic solution is held by a polymer compound. The electrolyte layer 36 may contain other material such as an additive according to needs. The electrolyte layer 36 is a so-called gel electrolyte. The gel electrolyte is preferable, since high ion conductivity (for example, 1 mS/cm or more at room temperature) is obtained and liquid leakage of the electrolytic solution is prevented.

Examples of polymer compounds include one or more of the following polymer materials. That is, examples thereof include polyacrylonitrile, polyvinylidene fluoride, polytetrafluoroethylene, polyhexafluoropropylene, polyethylene oxide, polypropylene oxide, polyphosphazene, polysiloxane, and polyvinyl fluoride. Further, examples thereof include polyvinyl acetate, polyvinyl alcohol, polymethacrylic acid methyl, polyacrylic acid, polymethacrylic acid, styrene-butadiene rubber, nitrile-butadiene rubber, polystyrene, and polycarbonate. Further, examples thereof include a copolymer of vinylidene fluoride and hexafluoropropylene. Specially, polyvinylidene fluoride or the copolymer of vinylidene fluoride and hexafluoropropylene is preferable, since such a polymer compound is electrochemically stable.

The composition of the electrolytic solution is similar to the composition of the electrolytic solution described in the cylindrical type secondary battery. However, in the electrolyte layer 36 as the gel electrolyte, a nonaqueous solvent of the electrolytic solution means a wide concept including not only the liquid solvent but also a material having ion conductivity capable of dissociating the electrolyte salt. Therefore, in the case where the polymer compound having ion conductivity is used, the polymer compound is also included in the solvent.

Instead of the gel electrolyte layer 36, the electrolytic solution may be directly used. In this case, the separator 35 is impregnated with the electrolytic solution.

Operation of the Secondary Battery

In the secondary battery, at the time of charge, for example, lithium ions extracted from the cathode 33 are inserted in the anode 34 through the electrolyte layer 36. Further, at the time of discharge, for example, lithium ions extracted from the anode 34 are inserted in the cathode 33 through the electrolyte layer 36.

Manufacturing Method of the Secondary Battery

The secondary battery including the gel electrolyte layer 36 is manufactured, for example, by the following three procedures.

In the first procedure, first, the cathode 33 and the anode 34 are formed by a formation procedure similar to that of the cathode 21 and the anode 22. In this case, the cathode 33 is formed by forming the cathode active material layer 33B on both faces of the cathode current collector 33A, and the anode 34 is formed by forming the anode active material layer 34B on both faces of the anode current collector 34A. Subsequently, a precursor solution containing an electrolytic solution, a polymer compound, and a solvent such as an organic solvent is prepared. After that, the cathode 33 and the anode 34 are coated with the precursor solution to form the gel electrolyte layer 36. Subsequently, the cathode lead 31 is attached to the cathode current collector 33A by welding or the like and the anode lead 32 is attached to the anode current collector 34A by welding or the like. Subsequently, the cathode 33 and the anode 34 provided with the electrolyte layer 36 are layered with the separator 35 in between and spirally wound to form the spirally wound electrode body 30. After that, the protective tape 37 is adhered to the outermost periphery thereof. Finally, after the spirally wound electrode body 30 is sandwiched between two pieces of film-like package members 40, outer edges of the package members 40 are contacted by thermal fusion bonding or the like to enclose the spirally wound electrode body 30 into the package members 40. In this case, the adhesive films 41 are inserted between the cathode lead 31, the anode lead 32 and the package member 40.

In the second procedure, first, the cathode lead 31 is attached to the cathode 33, and the anode lead 32 is attached to the anode 34. Subsequently, the cathode 33 and the anode 34 are layered with the separator 35 in between and spirally wound to form a spirally wound body as a precursor of the spirally wound electrode body 30. After that, the protective tape 37 is adhered to the outermost periphery thereof. Subsequently, after the spirally wound body is sandwiched between two pieces of the film-like package members 40, the outermost peripheries except for one side are bonded by thermal fusion bonding or the like to obtain a pouched state, and the spirally wound body is contained in the pouch-like package member 40. Subsequently, a composition of matter for electrolyte containing an electrolytic solution, a monomer as a raw material for the polymer compound, a polymerization initiator, and if necessary other material such as a polymerization inhibitor is prepared, which is injected into the pouch-like package member 40. After that, the opening of the package member 40 is hermetically sealed by using thermal fusion bonding or the like. Finally, the monomer is thermally polymerized to obtain a polymer compound. Thereby, the gel electrolyte layer 36 is formed.

In the third procedure, the spirally wound body is formed and contained in the pouch-like package member 40 in the same manner as that of the foregoing second procedure, except that the separator 35 with both faces coated with a polymer compound is used firstly. Examples of polymer compounds with which the separator 35 is coated include a polymer containing vinylidene fluoride as a component (a homopolymer, a copolymer, a multicomponent copolymer or the like). Specific examples thereof include polyvinylidene fluoride, a binary copolymer containing vinylidene fluoride and hexafluoropropylene as a component, and a ternary copolymer containing vinylidene fluoride, hexafluoropropylene, and chlorotrifluoroethylene as a component. In addition to the polymer containing vinylidene fluoride as a component, another one or more polymer compounds may be used. Subsequently, an electrolytic solution is prepared and injected into the package member 40. After that, the opening of the package member 40 is sealed by thermal fusion bonding method or the like. Finally, the resultant is heated while a weight is applied to the package member 40, and the separator 35 is contacted with the cathode 33 and the anode 34 with the polymer compound in between. Thereby, the polymer compound is impregnated with the electrolytic solution, and accordingly the polymer compound is gelated to form the electrolyte layer 36.

In the third procedure, the swollenness of the battery is inhibited compared to the first procedure. Further, in the third procedure, the monomer, the solvent and the like as a raw material of the polymer compound are hardly left in the electrolyte layer 36 compared to the second procedure. Thus, the formation step of the polymer compound is favorably controlled. Therefore, sufficient contact characteristics are obtained between the cathode 33/the anode 34/the separator 35 and the electrolyte layer 36.

Action and Effect of the Secondary Battery

According to the secondary battery, the electrolyte layer 36 contains the foregoing electrolytic solution. Therefore, battery characteristics such as cycle characteristics and storage characteristics are able to be improved by action similar to that of the cylindrical type secondary battery. Other action and effect of the secondary battery are similar to those of the electrolytic solution.

2-3. Lithium Metal Secondary Battery (Cylindrical Type and Laminated Film Type)

A secondary battery hereinafter described is a lithium metal secondary battery in which the anode capacity is expressed by precipitation and dissolution of lithium metal. The secondary battery has a structure similar to that of the foregoing lithium ion secondary battery (cylindrical type), except that the anode active material layer 22B is formed from lithium metal, and is manufactured by a procedure similar to that of the foregoing lithium ion secondary battery (cylindrical type).

In the secondary battery, lithium metal is used as an anode active material, and thereby a higher energy density is able to be obtained. It is possible that the anode active material layer 22B previously exists at the time of assembling, or the anode active material layer 22B does not exist at the time of assembling and is to be formed from lithium metal to be precipitated at the time of charge. Further, it is possible that the anode active material layer 22B is used as a current collector as well, and the anode current collector 22A is omitted.

In the secondary battery, at the time of charge, for example, lithium ions extracted from the cathode 21 are precipitated as lithium metal on the surface of the anode current collector 22A through the electrolytic solution. Meanwhile, at the time of discharge, for example, lithium metal is eluted as lithium ions from the anode active material layer 22B, and is inserted in the cathode 21 through the electrolytic solution.

The lithium metal secondary battery includes the foregoing electrolytic solution for a secondary battery as an electrolytic solution. Therefore, cycle characteristics, storage characteristics, and voltage characteristics are able to be improved by action similar to that of the lithium ion secondary battery. Other effects of the lithium metal secondary battery are similar to those of the electrolytic solution. The foregoing lithium metal secondary battery is not limited to the cylindrical type secondary battery, and may be a laminated film type secondary battery illustrated in FIG. 3 and FIG. 4. In this case, similar effect is able to be also obtained.

3. Application of the Secondary Battery

Next, a description will be given of an application example of the foregoing secondary battery.

Applications of the secondary battery are not particularly limited as long as the secondary battery is used for a machine, a device, an instrument, an equipment, a system (collective entity of a plurality of devices and the like) or the like that is able to use the secondary battery as a drive power source, an electric power storage source for electric power storage or the like. In the case where the secondary battery is used as a power source, the secondary battery may be used as a main power source (power source used preferentially), or an auxiliary power source (power source used instead of a main power source or used being switched from the main power source). In the latter case, the main power source type is not limited to the secondary battery.

Examples of applications of the secondary battery include portable electronic devices such as a video camera, a digital still camera, a mobile phone, a notebook personal computer, a cordless phone, a headphone stereo, a portable radio, a portable television, and a Personal Digital Assistant (PDA); a lifestyle device such as an electric shaver; a storage equipment such as a backup power source and a memory card; an electric power tool such as an electric drill and an electric saw; a medical electronic device such as a pacemaker and a hearing aid; an electrical vehicle (including a hybrid car); and an electric power storage system such as a home battery system for storing electric power for emergency or the like.

Specially, the secondary battery is effectively applicable to the electric power tool, the electrical vehicle, the electric power storage system or the like. In these applications, since superior characteristics of the secondary battery are demanded, the characteristics are able to be effectively improved by using the secondary battery. The electric power tool is a tool in which a moving part (for example, a drill or the like) is moved by using the secondary battery as a driving power source. The electrical vehicle is a vehicle that acts (runs) by using the secondary battery as a driving power source. As described above, a vehicle including the drive source as well other than the secondary battery (hybrid vehicle or the like) may be adopted. The electric power storage system is a system using the secondary battery as an electric power storage source. For example, in a home electric power storage system, electric power is stored in the secondary battery as an electric power storage source, and the electric power stored in the secondary battery is consumed according to needs. In the result, various devices such as home electric products become usable.

### EXAMPLES

Specific examples will be described in detail.

### Examples 1-1 to 1-40

The cylindrical type secondary battery (lithium ion secondary battery) illustrated in FIG. 1 and FIG. 2 was fabricated by the following procedure.

First, the cathode 21 was formed. First, lithium carbonate (Li₂CO₃) and cobalt carbonate (CoCO₃) were mixed at a molar ratio of 0.5:1. After that, the mixture was fired in the air at 900 deg C. for 5 hours. Thereby, lithium-cobalt composite oxide (LiCoO₂) was obtained. Subsequently, 91 parts by mass of LiCoO₂ as a cathode active material, 6 parts by mass of graphite as a cathode conductive agent, and 3 parts by mass of polyvinylidene fluoride as a cathode binder were mixed to obtain a cathode mixture. Subsequently, the cathode mixture was dispersed in N-methyl-2-pyrrolidone (NMP) to obtain paste cathode mixture slurry. Subsequently, both faces of the cathode current collector 21A were coated with the cathode mixture slurry by a coating device, which was dried to form the cathode active material layer 21B. As the cathode current collector 21A, a strip-shaped aluminum foil (thickness: 20 μm) was used. After that, the cathode active material layer 21B was compression-molded by a roll pressing machine.

Next, the anode 22 was formed. First, 90 parts by mass of the carbon material (artificial graphite) as an anode active material and 10 parts by mass of polyvinylidene fluoride as an anode binder were mixed to obtain an anode mixture. Subsequently, the anode mixture was dispersed in NMP to obtain paste anode mixture slurry. Subsequently, both faces of the anode current collector 22A were coated with the anode mixture slurry by using a coating device, which was dried to form the anode active material layer 22B. As the anode current collector 22A, a strip-shaped electrolytic copper foil (thickness: 15 μm) was used. After that, the anode active material layer 22B was compression-molded by a roll pressing machine.

Next, an electrolyte salt (lithium hexafluorophosphate (LiPF₆)) was dissolved in nonaqueous solvents (ethylene carbonate (EC) and dimethyl carbonate (DMC)), to which a sulfonic acid anhydride or vinylene carbonate (VC) was subsequently added thereto according to needs to prepare an electrolytic solution. In this case, the mixture ratio (weight ratio) of the nonaqueous solvents was EC:DMC=30:70, and the content of the electrolyte salt to the solvent was 1 mol/kg. For changing the content of chlorine ions, the number of recrystallization at the time of refining was changed for the sulfonic acid anhydride, and the number of distillation at the time of refining was changed for vinylene carbonate. Other detailed composition of the electrolytic solution was as illustrated in Table 1 to Table 4.

Finally, the secondary battery was assembled by using the cathode 21, the anode 22, and the electrolytic solution. First, the cathode lead 25 was welded to the cathode current collector 21A, and the anode lead 26 was welded to the anode current collector 22A. Subsequently, the cathode 21 and the anode 22 were layered with the separator 23 in between and spirally wound to form the spirally wound electrode body 20. After that, the center pin 24 was inserted in the center of the spirally wound electrode body. As the separator 23, a microporous polypropylene film (thickness: 25 μm) was used. Subsequently, while the spirally wound electrode body 20 was sandwiched between the pair of insulating plates 12 and 13, the spirally wound electrode body 20 was contained in the iron battery can 11 plated with nickel. In this case, the cathode lead 25 was welded to the safety valve mechanism 15, and the anode lead 26 was welded to the battery can 11. Subsequently, the electrolytic solution was injected into the battery can 11 by depressurization method, and the separator 23 was impregnated with the electrolytic solution. After that, at the open end of the battery can 11, the battery cover 14, the safety valve mechanism 15, and the PTC device 16 were fixed by being caulked with the gasket 17. The cylindrical type secondary battery was thereby completed. In forming the secondary battery, lithium metal was prevented from being precipitated on the anode 22 at the full charged state by adjusting the thickness of the cathode active material layer 21B.

The cycle characteristics, the storage characteristics, and the voltage characteristics for the secondary batteries were examined. The results illustrated in Table 1 to Table 4 were obtained.

In examining the cycle characteristics, first, two cycles of charge and discharge were performed in the atmosphere at 23 deg C., and the discharge capacity was measured. Subsequently, the secondary battery was charged and discharged repeatedly in the same atmosphere until the total number of cycles became 100 cycles, and thereby the discharge capacity was measured. After that, the cycle retention ratio (%)=(discharge capacity at the 100th cycle/discharge capacity at the second cycle)*100 was calculated. At the time of charge, constant current and constant voltage charge was performed at a charge current of 0.2 C until the upper voltage of 4.2 V. At the time of discharge, constant current discharge was performed at a discharge current of 0.2 C until the final voltage of 2.5 V. “0.2 C” is a current value at which the theoretical capacity is completely discharged in 5 hours.

In examining the storage characteristics, first, as in the case of examining the cycle characteristics, after 2 cycles of charge and discharge were performed in the atmosphere at 23 deg C., the discharge capacity was measured. Subsequently, after the battery was stored in a constant temperature bath at 80 deg C. for 10 days in a state of being charged again, discharge was performed in the atmosphere at 23 deg C., and the discharge capacity was measured. After that, the storage retention ratio (%)=(discharge capacity after storage/discharge capacity before storage)*100 was calculated. The charge and discharge conditions were similar to those in the case of examining the cycle characteristics.

In examining the voltage characteristics, first, as in the case of examining the cycle characteristics, after 2 cycles of charge and discharge was performed in the atmosphere at 23 deg C., the discharge capacity was measured. Subsequently, after the battery was stored in a constant temperature bath at 60 deg C. for 30 days in a state of being charged again, closed circuit voltage (V) in the atmosphere at 23 deg C. was measured. The charge and discharge conditions were similar to those in the case of examining the cycle characteristics.

TABLE 1
Anode active material: artificial graphite

| | | Nonaqueous solvent | | | | Cycle | Storage | Closed |
|---|---|---|---|---|---|---|---|---|
| | | | | Cl⁻ | | retention | retention | circuit |
| | Electrolyte | | Content | Content | | ratio | ratio | voltage |
| Table 1 | salt | Type | (wt %) | (ppm) | Type | (%) | (%) | (V) |
| Example 1-1 | LiPF₆ | (1-1) | 1 | 0 | EC + DMC | 78 | 90 | 4.122 |
| Example 1-2 | | | | 6 | | 78 | 90 | 4.122 |
| Example 1-3 | | | | 50 | | 78 | 90 | 4.122 |
| Example 1-4 | | | | 469 | | 76 | 88 | 4.122 |
| Example 1-5 | | | | 959 | | 76 | 88 | 4.120 |
| Example 1-6 | | | | 1999 | | 76 | 86 | 4.117 |
| Example 1-7 | | | | 4530 | | 75 | 86 | 4.112 |
| Example 1-8 | | | | 5110 | | 75 | 86 | 4.111 |
| Example 1-9 | | | | 6500 | | 73 | 82 | 3.460 |
| Example 1-10 | LiPF₆ | (1-1) | 0.001 | 50 | EC + DMC | 76 | 85 | 4.121 |
| Example 1-11 | | | 0.1 | | | 76 | 85 | 4.122 |
| Example 1-12 | | | 0.2 | | | 77 | 86 | 4.122 |
| Example 1-13 | | | 2 | | | 78 | 92 | 4.122 |
| Example 1-14 | | | 5 | | | 75 | 92 | 4.122 |

TABLE 2
Anode active material: artificial graphite

| | | Nonaqueous solvent | | | | Cycle | Storage | Closed |
|---|---|---|---|---|---|---|---|---|
| | | | | Cl⁻ | | retention | retention | circuit |
| | Electrolyte | | Content | Content | | ratio | ratio | voltage |
| Table 2 | salt | Type | (wt %) | (ppm) | Type | (%) | (%) | (V) |
| Example 1-15 | LiPF₆ | (1-2) | 1 | 0 | EC + DMC | 80 | 92 | 4.130 |
| Example 1-16 | | | | 6 | | 80 | 92 | 4.130 |
| Example 1-17 | | | | 50 | | 80 | 92 | 4.130 |
| Example 1-18 | | | | 469 | | 76 | 89 | 4.129 |
| Example 1-19 | | | | 959 | | 76 | 89 | 4.126 |
| Example 1-20 | | | | 1999 | | 76 | 88 | 4.126 |
| Example 1-21 | | | | 4530 | | 76 | 88 | 4.126 |
| Example 1-22 | | | | 5110 | | 76 | 88 | 4.125 |
| Example 1-23 | | | | 6500 | | 74 | 83 | 3.380 |

TABLE 3
Anode active material: artificial graphite

| | | Nonaqueous solvent | | | | Cycle | Storage | Closed |
|---|---|---|---|---|---|---|---|---|
| | | | | Cl⁻ | | retention | retention | circuit |
| | Electrolyte | | Content | Content | | ratio | ratio | voltage |
| Table 3 | salt | Type | (wt %) | (ppm) | Type | (%) | (%) | (V) |
| Example 1-24 | LiPF₆ | (2-1) | 1 | 0 | EC + DMC | 78 | 90 | 4.120 |
| Example 1-25 | | | | 6 | | 78 | 90 | 4.120 |
| Example 1-26 | | | | 50 | | 78 | 90 | 4.120 |
| Example 1-27 | | | | 469 | | 76 | 88 | 4.120 |
| Example 1-28 | | | | 959 | | 76 | 88 | 4.120 |
| Example 1-29 | | | | 1999 | | 76 | 86 | 4.118 |
| Example 1-30 | | | | 4530 | | 75 | 85 | 4.114 |
| Example 1-31 | | | | 5110 | | 75 | 85 | 4.112 |
| Example 1-32 | | | | 6500 | | 73 | 82 | 3.500 |
| Example 1-33 | LiPF₆ | (2-1) | 0.001 | 50 | EC + DMC | 76 | 85 | 4.120 |
| Example 1-34 | | | 0.1 | | | 76 | 88 | 4.120 |
| Example 1-35 | | | 0.2 | | | 76 | 89 | 4.120 |
| Example 1-36 | | | 2 | | | 78 | 92 | 4.120 |
| Example 1-37 | | | 5 | | | 76 | 92 | 4.120 |

TABLE 4
Anode active material: artificial graphite

| | | Nonaqueous solvent | | | | Cycle | Storage | Closed |
|---|---|---|---|---|---|---|---|---|
| | | | | Cl⁻ | | retention | retention | circuit |
| | Electrolyte | | Content | Content | | ratio | ratio | voltage |
| Table 4 | salt | Type | (wt %) | (ppm) | Type | (%) | (%) | (V) |
| Example 1-38 | LiPF₆ | — | — | — | EC + DMC | 75 | 81 | 4.122 |
| Example 1-39 | | VC | 1 | 50 | | 84 | 83 | 4.124 |
| Example 1-40 | | | | 6500 | | 82 | 83 | 4.120 |

In the case where the electrolytic solution contained the chlorine ions together with the sulfonic acid anhydride, if the content of the chlorine ions was 5000 wt ppm or less, favorable result was obtained compared to the case that the electrolytic solution did not contain both the sulfonic acid anhydride and the chlorine ions. More specifically, the cycle retention ratio was an equal value or more, the storage retention ratio was higher, and the closed circuit voltage was hardly lowered. The result showed the following fact. That is, in the case where the sulofnic acid anhydride was used under the presence of the chlorine ions, the sulofnic acid anhydride was affected by the chlorine ions. Thus, unless the content of the chlorine ions is kept down to 5000 wt ppm or less, decomposition reaction of the electrolytic solution is not effectively inhibited at the time of charge and discharge and in high temperature atmosphere.

In the case where vinylene carbonate was used instead of the sulfonic acid anhydride, since vinylene carbonate was not affected by the chlorine ions, favorable result was obtained not depending on the content of the chlorine ions. More specifically, the cycle retention ratio and the storage retention ratio were increased, and the closed circuit voltage was hardly lowered. The result showed the following fact. That is, keeping the content of the chlorine ions to a given amount was not necessary for vinylene carbonate, and was necessary for only the sulfonic acid anhydride.

### Examples 2-1 to 2-7

Secondary batteries were fabricated by a similar procedure except that the composition of the nonaqueous solvent was changed as illustrated in Table 5, and respective characteristics were examined. In this case, as a new nonaqueous solvent, 4-fluoro-1,3-dioxolane-2-one (FEC), trans-4,5-difluoro-1,3-dioxolane-2-one (DFEC), propene sultone (PRS), or succinic anhydride (SCAH) was added, and the content thereof in the nonaqueous solvent was 5 wt %.

TABLE 5
Anode active material: artificial graphite

| | | Nonaqueous solvent | | | | | Cycle | Storage | Closed |
|---|---|---|---|---|---|---|---|---|---|
| | | | | Cl⁻ | | | retention | retention | circuit |
| | Electrolyte | | Content | Content | | | ratio | ratio | voltage |
| Table 5 | salt | Type | (wt/kg) | (ppm) | Type | | (%) | (%) | (V) |
| Example 2-1 | LiPF₆ | (1-2) | 1 | 50 | EC + DMC | VC | 85 | 94 | 4.123 |
| Example 2-2 | | | | | | FEC | 84 | 92 | 4.120 |
| Example 2-3 | | | | | | DFEC | 84 | 92 | 4.122 |
| Example 2-4 | | | | | | PRS | 84 | 94 | 4.126 |
| Example 2-5 | | | | | | SCAH | 85 | 94 | 4.122 |
| Example 2-6 | LiPF₆ | — | — | — | EC + DMC | FEC | 80 | 84 | 4.120 |
| Example 2-7 | | | | | | DFEC | 80 | 84 | 4.122 |

In the case where the composition of the nonaqueous solvent was changed, high cycle retention ratio, high storage retention ratio, and high closed circuit voltage were obtained as in the results of Table 1 to Table 4. In particular, in the case where FEC or the like was added, the cycle retention ratio and the storage retention ratio were further increased.

### Examples 3-1 to 3-3

As illustrated in Table 6, secondary batteries were fabricated by a similar procedure except that the composition of the electrolyte salt was changed as illustrated in Table 6, and the respective characteristics were examined. In this case, as a new electrolyte salt, lithium tetrafluoroborate (LiBF₄), lithium (4,4,4-trifluorobutyrate oxalato) borate (LiTFOB) shown in Formula (9-8), or lithium bis(trifluoromethanesulfonyl)imide (LiN(CF₃SO₂)₂: LiTFSI) was added. In this case, the content of LiPF₆ to the nonaqueous solvent was 0.9 mol/kg, and the content of LiBF₄ or the like to the nonaqueous solvent was 0.1 mol/kg.

TABLE 6
Anode active material: artificial graphite

| | | | Nonaqueous solvent | | | | Cycle | Storage | Closed |
|---|---|---|---|---|---|---|---|---|---|
| | | | | | Cl⁻ | | retention | retention | circuit |
| | | | | Content | Content | | ratio | ratio | voltage |
| Table 6 | Electrolyte salt | | Type | (wt %) | (ppm) | Type | (%) | (%) | (V) |
| Example 3-1 | LiPF₆ | LiBF₄ | (1-2) | 1 | 50 | EC + | 82 | 95 | 4.124 |
| Example 3-2 | | LiTFOB | | | | DMC | 82 | 93 | 4.124 |
| Example 3-3 | | LiTFSI | | | | | 83 | 92 | 4.126 |

In the case where the composition of the electrolyte salt was changed, high cycle retention ratio, high storage retention ratio, and high closed circuit voltage were obtained as the results of Table 1 to Table 4. In particular, in the case where LiBF₄ or the like was added, the cycle retention ratio and the storage retention ratio were further increased.

### Examples 4-1 to 4-40

Secondary batteries were fabricated by a procedure similar to that of Examples 1-1 to 1-40 except that a metal material (silicon) was used as an anode active material, and the composition of the nonaqueous solvent was changed by using diethyl carbonate (DEC) as illustrated in Table 7 to Table 10, and the respective characteristics were examined. In forming the anode 22, silicon was deposited on the surface of the anode current collector 22A by using evaporation method (electron beam evaporation method) to form the anode active material layer 22B. In this case, 10 times of deposition steps were repeated to obtain the total thickness of the anode active material layer 22B of 6 μm.

TABLE 7
Anode active material: silicon

| | | Nonaqueous solvent | | | | Cycle | Storage | Closed |
|---|---|---|---|---|---|---|---|---|
| | | | | Cl⁻ | | retention | retention | circuit |
| | Electrolyte | | Content | Content | | ratio | ratio | voltage |
| Table 7 | salt | Type | (wt %) | (ppm) | Type | (%) | (%) | (V) |
| Example 4-1 | LiPF₆ | (1-1) | 1 | 0 | EC + DEC | 45 | 90 | 4.022 |
| Example 4-2 | | | | 6 | | 45 | 90 | 4.022 |
| Example 4-3 | | | | 50 | | 45 | 90 | 4.022 |
| Example 4-4 | | | | 469 | | 43 | 87 | 4.022 |
| Example 4-5 | | | | 959 | | 43 | 87 | 4.020 |
| Example 4-6 | | | | 1999 | | 41 | 85 | 4.017 |
| Example 4-7 | | | | 4530 | | 40 | 85 | 4.012 |
| Example 4-8 | | | | 5110 | | 40 | 85 | 4.011 |
| Example 4-9 | | | | 6500 | | 37 | 82 | 3.060 |
| Example 4-10 | LiPF₆ | (1-1) | 0.001 | 50 | EC + DEC | 42 | 84 | 4.022 |
| Example 4-11 | | | 0.1 | | | 43 | 85 | 4.022 |
| Example 4-12 | | | 0.2 | | | 44 | 88 | 4.022 |
| Example 4-13 | | | 2 | | | 45 | 92 | 4.022 |
| Example 4-14 | | | 5 | | | 42 | 90 | 4.022 |

TABLE 8
Anode active material: silicon

| | | Nonaqueous solvent | | | | Cycle | Storage | Closed |
|---|---|---|---|---|---|---|---|---|
| | | | | Cl⁻ | | retention | retention | circuit |
| | Electrolyte | | Content | Content | | ratio | ratio | voltage |
| Table 8 | salt | Type | (wt %) | (ppm) | Type | (%) | (%) | (V) |
| Example 4-15 | LiPF₆ | (1-2) | 1 | 0 | EC + DEC | 48 | 93 | 4.030 |
| Example 4-16 | | | | 6 | | 48 | 93 | 4.030 |
| Example 4-17 | | | | 50 | | 48 | 93 | 4.030 |
| Example 4-18 | | | | 469 | | 46 | 92 | 4.029 |
| Example 4-19 | | | | 959 | | 45 | 90 | 4.026 |
| Example 4-20 | | | | 1999 | | 42 | 88 | 4.026 |
| Example 4-21 | | | | 4530 | | 42 | 87 | 4.026 |
| Example 4-22 | | | | 5110 | | 42 | 87 | 4.025 |
| Example 4-23 | | | | 6500 | | 38 | 83 | 3.020 |

TABLE 9
Anode active material: silicon

| | | Nonaqueous solvent | | | | Cycle | Storage | Closed |
|---|---|---|---|---|---|---|---|---|
| | | | | Cl⁻ | | retention | retention | circuit |
| | Electrolyte | | Content | Content | | ratio | ratio | voltage |
| Table 9 | salt | Type | (wt %) | (ppm) | Type | (%) | (%) | (V) |
| Example 4-24 | LiPF₆ | (2-1) | 1 | 0 | EC + DEC | 44 | 90 | 4.020 |
| Example 4-25 | | | | 6 | | 44 | 90 | 4.020 |
| Example 4-26 | | | | 50 | | 44 | 90 | 4.020 |
| Example 4-27 | | | | 469 | | 42 | 87 | 4.020 |
| Example 4-28 | | | | 959 | | 42 | 87 | 4.020 |
| Example 4-29 | | | | 1999 | | 41 | 85 | 4.018 |
| Example 4-30 | | | | 4530 | | 40 | 85 | 4.014 |
| Example 4-31 | | | | 5110 | | 40 | 85 | 4.012 |
| Example 4-32 | | | | 6500 | | 36 | 82 | 3.000 |
| Example 4-33 | LiPF₆ | (2-1) | 0.001 | 50 | EC + DEC | 42 | 85 | 4.020 |
| Example 4-34 | | | 0.1 | | | 42 | 87 | 4.020 |
| Example 4-35 | | | 0.2 | | | 43 | 88 | 4.020 |
| Example 4-36 | | | 2 | | | 44 | 92 | 4.020 |
| Example 4-37 | | | 5 | | | 42 | 92 | 4.020 |

TABLE 10
Anode active material: silicon

| | | Nonaqueous solvent | | | | Cycle | Storage | Closed |
|---|---|---|---|---|---|---|---|---|
| | | | | Cl⁻ | | retention | retention | circuit |
| | Electrolyte | | Content | Content | | ratio | ratio | voltage |
| Table 10 | salt | Type | (wt %) | (ppm) | Type | (%) | (%) | (V) |
| Example 4-38 | LiPF₆ | — | — | — | EC + DEC | 40 | 81 | 4.020 |
| Example 4-39 | | VC | 1 | 50 | | 72 | 84 | 4.020 |
| Example 4-40 | | | | 6500 | | 70 | 84 | 4.024 |

In the case where the metal material was used as an anode active material, results similar to those in the case of using the carbon material (Table 1 to Table 4) were obtained. That is, high cycle retention ratio, high storage retention ratio, and high closed circuit ratio were obtained.

### Examples 5-1 to 5-7

Secondary batteries were fabricated by a procedure similar to that of Examples 2-1 to 2-7 except that the composition of the nonaqueous solvent was changed as illustrated in Table 11, and the respective characteristics were examined.

TABLE 11
Anode active material: silicon

| | | Nonaqueous solvent | | | | | Cycle | Storage | Closed |
|---|---|---|---|---|---|---|---|---|---|
| | | | | Cl⁻ | | | retention | retention | circuit |
| | Electrolyte | | Content | Content | | | ratio | ratio | voltage |
| Table 11 | salt | Type | (wt %) | (ppm) | Type | | (%) | (%) | (V) |
| Example 5-1 | LiPF₆ | (1-2) | 1 | 50 | EC + DEC | VC | 75 | 95 | 4.023 |
| Example 5-2 | | | | | | FEC | 66 | 94 | 4.020 |
| Example 5-3 | | | | | | DFEC | 80 | 94 | 4.022 |
| Example 5-4 | | | | | | PRS | 49 | 95 | 4.026 |
| Example 5-5 | | | | | | SCAH | 50 | 95 | 4.022 |
| Example 5-6 | LiPF₆ | — | — | — | EC + DEC | FEC | 60 | 84 | 4.020 |
| Example 5-7 | | | | | | DFEC | 76 | 84 | 4.021 |

In the case where the metal material was used as an anode active material, high cycle retention ratio, high storage retention ratio, and high closed circuit voltage were obtained as in the case of using the carbon material (Table 5).

### Examples 6-1 to 6-3

Secondary batteries were fabricated by a procedure similar to that of Examples 3-1 to 3-3 except that the composition of the electrolyte salt was changed as illustrated in Table 12, and the respective characteristics were examined.

TABLE 12
Anode active material: silicon

| | | | Nonaqueous solvent | | | | Cycle | Storage | Closed |
|---|---|---|---|---|---|---|---|---|---|
| | | | | | Cl⁻ | | retention | retention | circuit |
| | | | | Content | Content | | ratio | ratio | voltage |
| Table 12 | Electrolyte salt | | Type | (wt %) | (ppm) | Type | (%) | (%) | (V) |
| Example 6-1 | LiPF₆ | LiBF₄ | (1-2) | 1 | 50 | EC + | 50 | 95 | 4.024 |
| Example 6-2 | | LiTFOB | | | | DEC | 50 | 95 | 4.024 |
| Example 6-3 | | LiTFSI | | | | | 52 | 95 | 4.026 |

In the case where the metal material was used as an anode active material, high cycle retention ratio, high storage retention ratio, and high closed circuit voltage were obtained as in the case of using the carbon material (Table 6).

From the results of Table 1 to Table 12, the following was derived. In this present disclosure, the electrolytic solution contained the chlorine ions together with the sulfonic acid anhydride, and the content of the chlorine ions was kept down to 5000 wt ppm or less. Therefore, superior cycle characteristics, superior storage characteristics, and superior voltage characteristics were able to be obtained without depending on the type of the anode active material, the composition of the nonaqueous solvent, the composition of the electrolyte salt and the like.

In this case, the increase ratios of the cycle retention ratio, the storage retention ratio, and the closed circuit voltage in the case that the metal material (silicon) was used as an anode active material were larger than those in the case that the carbon material (artificial graphite) was used as an anode active material. Accordingly, higher effect was able to be obtained in the case that the metal material (silicon) was used as an anode active material than in the case that the carbon material (artificial graphite) was used as an anode active material. The result may be obtained for the following reason. That is, in the case where the metal material advantageous to achieve a high capacity was used as an anode active material, the electrolytic solution was more easily decomposed than in a case that the carbon material was used. Accordingly, decomposition inhibition effect of the electrolytic solution was significantly demonstrated.

The present disclosure has been described with reference to the embodiment and the examples. However, the present disclosure is not limited to the aspects described in the embodiment and the aspects described in the examples, and various modifications may be made. For example, use application of the electrolytic solution for a secondary battery is not necessarily limited to the secondary battery, and may be other device such as a capacitor.

Further, in the embodiment and the examples, the description has been given of the lithium ion secondary battery or the lithium metal secondary battery as a secondary battery type. However, the secondary battery is not limited thereto. The present disclosure is similarly applicable to a secondary battery in which the anode capacity includes the capacity by inserting and extracting lithium ions and the capacity associated with precipitation and dissolution of lithium metal, and the anode capacity is expressed by the sum of these capacities. In this case, an anode material capable of inserting and extracting lithium ions is used as an anode active material, and the chargeable capacity of the anode material is set to a smaller value than the discharge capacity of the cathode.

Further, in the embodiment and the examples, the description has been given with the specific examples of the case in which the battery structure is the cylindrical type or the laminated film type, and with the specific example in which the battery element has the spirally wound structure. However, applicable structures are not limited thereto. The secondary battery is able to be similarly applicable to a battery having other battery structure such as a square type battery, a coin type battery, and a button type battery or a battery in which the battery element has other structure such as a laminated structure.

Further, in the embodiment and the examples, while the description has been given of the case that lithium is used as an element of the electrode reactant, the element of the electrode reactant is not limited thereto. The carrier may be other Group 1 element such as sodium (N) and potassium (K), Group 2 element such as magnesium and calcium, or other light metal such as aluminum. The effect is able to be obtained without depending on the electrode reactant type. Thus, even if the electrode reactant type is changed, similar effect is able to be obtained.

Further, in the embodiment and the examples, for the content of the chlorine ions, the description has been given of the appropriate range derived from the results of the examples. However, the description does not totally deny a possibility that the content is out of the foregoing range. That is, the foregoing appropriate range is the range particularly preferable for obtaining the effects. Therefore, as long as effect is obtained, the content may be out of the foregoing range in some degrees.

It should be understood that various changes and modifications to the presently preferred embodiments described herein will be apparent to those skilled in the art. Such changes and modifications can be made without departing from the spirit and scope and without diminishing its intended advantages. It is therefore intended that such changes and modifications be covered by the appended claims.

The application is claimed as follows:

1. An electrolytic solution for a secondary battery containing chlorine ions (Cl—) together with a nonaqueous solvent and an electrolyte salt,
wherein the nonaqueous solvent contains one or both of sulfonic acidanhydrides shown in Formula 1 and Formula 2, and
a content of the chlorine ions is 5000 wt ppm or less. 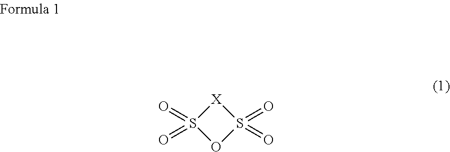
where X is a divalent hydrocarbon group or a derivative thereof. 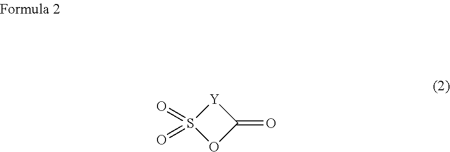
where Y is a divalent hydrocarbon group or a derivative thereof.

2. The electrolytic solution for a secondary battery according to claim 1, wherein the content of the chlorine ions is 50 wt ppm or less.

3. The electrolytic solution for a secondary battery according to claim 1, wherein the X and the Y are an alkylene group in a straight chain state or a branched state with a carbon number from 2 to 4 both inclusive, an alkenylene group in a straight chain state or a branched state with a carbon number from 2 to 4 both inclusive, an arylene group, or a derivative thereof.

4. The electrolytic solution for a secondary battery according to claim 1, wherein the sulfonic acid anhydride shown in Formula 1 is at least one of compounds expressed by Formula (1-1) to Formula (1-19), and the sulfonic acid anhydride shown in Formula 2 is at least one of compounds expressed by Formula (2-1) to Formula (2-15).

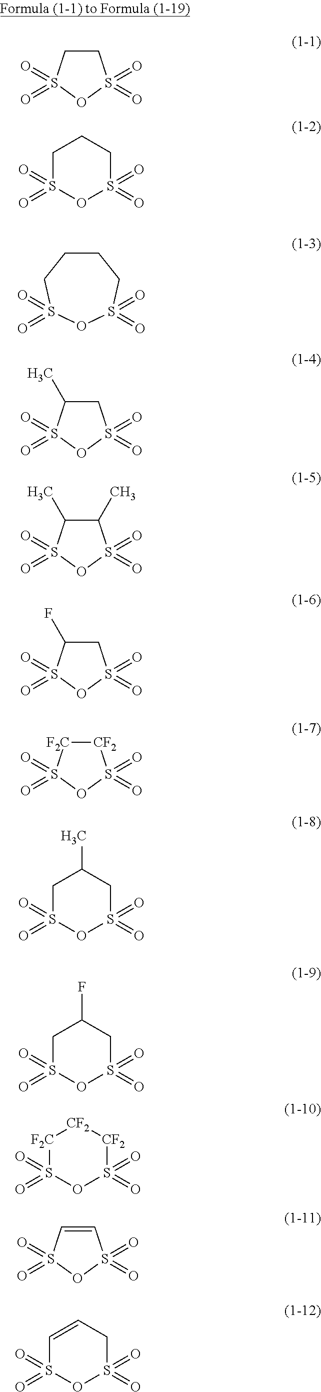

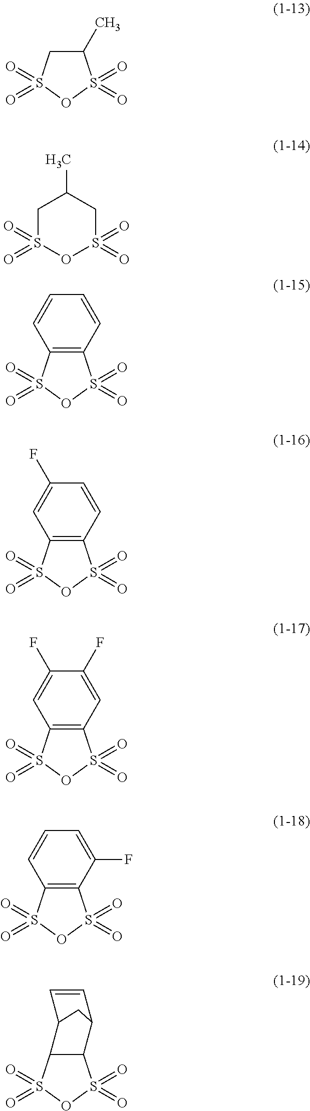

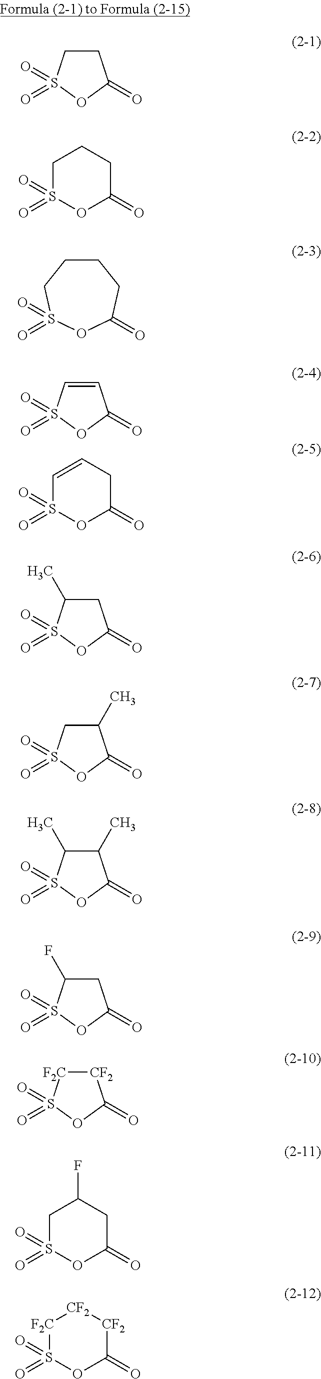

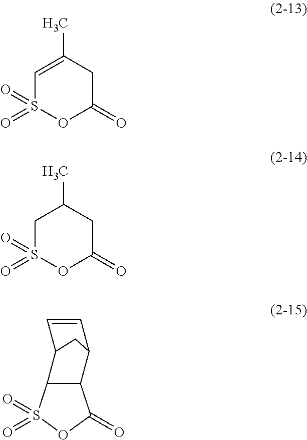

5. The electrolytic solution for a secondary battery according to claim 1, wherein a content of the sulfonic acid anhydride in the nonaqueous solvent is from 0.001 wt % to 5 wt % both inclusive.

6. A secondary battery comprising:
a cathode;
an anode; and
an electrolytic solution,
wherein the electrolytic solution contains chlorine ions together with a nonaqueous solvent and an electrolyte salt,
the nonaqueous solvent contains one or both of sulfonic acid anhydrides shown in Formula 1 and Formula 2, and
a content of the chlorine ions is 5000 wt ppm or less. 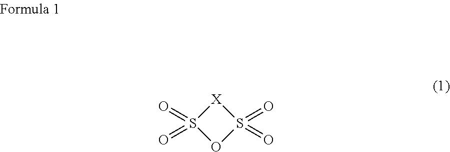
where X is a divalent hydrocarbon group or a derivative thereof. 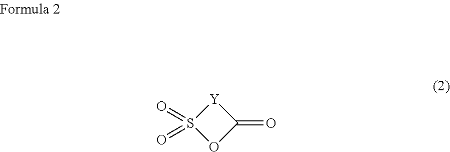
where Y is a divalent hydrocarbon group or a derivative thereof.

7. The secondary battery according to claim 6, wherein the content of the chlorine ions is 50 ppm or less.

8. The secondary battery according to claim 6, wherein the X and the Y are an alkylene group in a straight chain state or a branched state with a carbon number from 2 to 4 both inclusive, an alkenylene group in a straight chain state or a branched state with a carbon number from 2 to 4 both inclusive, an arylene group, a halogenated group thereof, or a derivative thereof.

9. The secondary battery according to claim 6, wherein the sulfonic acid anhydride shown in Formula 1 is at least one of compounds expressed by Formula (1-1) to Formula (1-19), and the sulfonic acid anhydride shown in Formula 2 is at least one of compounds expressed by Formula (2-1) to Formula (2-15).

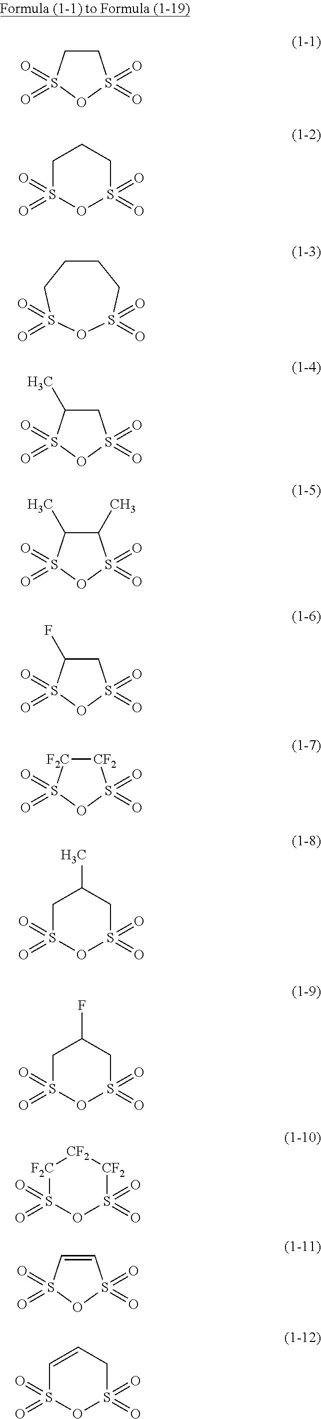

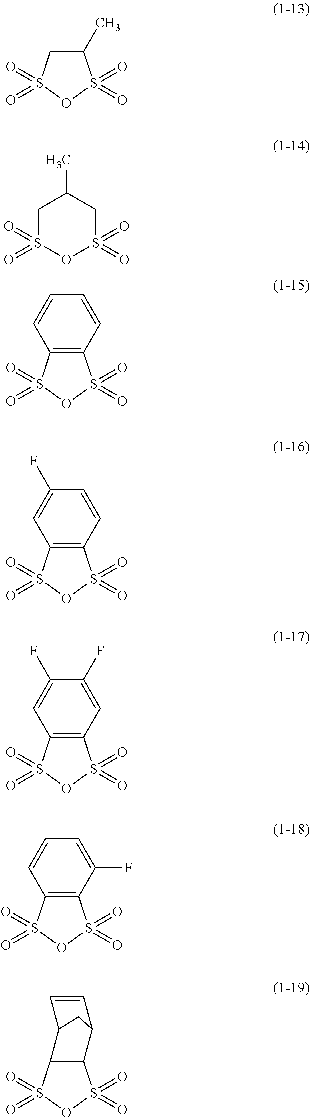

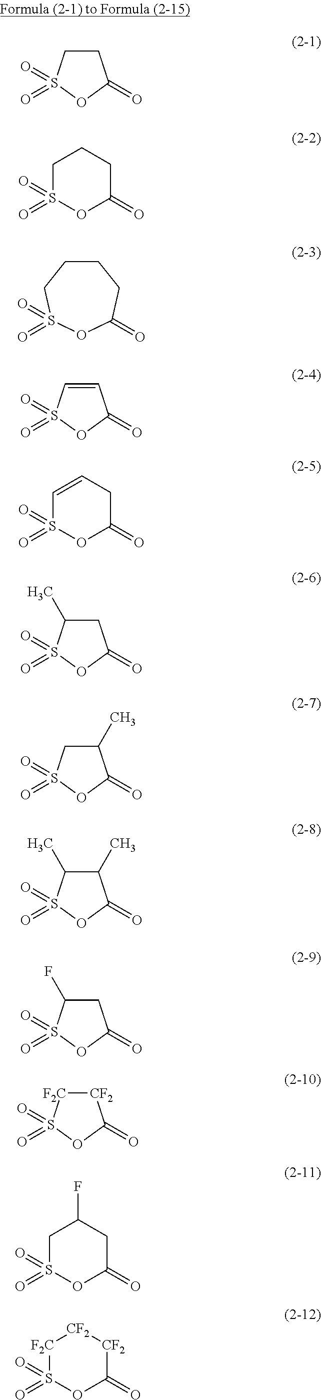

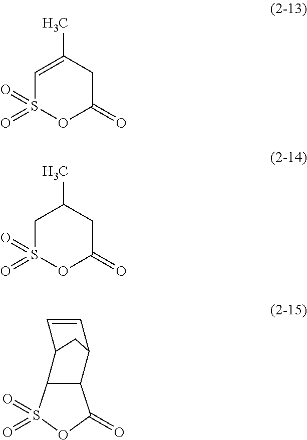

10. The secondary battery according to claim 6, wherein a content of the sulfonic acid anhydride in the nonaqueous solvent is from 0.001 wt % to 5 wt % both inclusive.

11. The secondary battery according to claim 6, wherein the anode contains a carbon material, lithium metal (Li), or a material that is able to insert and extract lithium ion and that has at least one of a metal element and a metalloid element as an element as an anode active material.

12. The secondary battery according to claim 6, wherein the anode contains a material having one or both of silicon (Si) and tin (Sn) as an element as an anode active material.

13. The secondary battery according to claim 6, wherein the secondary battery is a lithium secondary battery.

14. An electric power tool moving with the use of a secondary battery including a cathode, an anode, and an electrolytic solution as a power source,
wherein the electrolytic solution contains chlorine ions together with a nonaqueous solvent and an electrolyte salt,
the nonaqueous solvent contains one or both of sulfonic acid anhydrides shown in Formula 1 and Formula 2, and
a content of the chlorine ions is 5000 wt ppm or less. 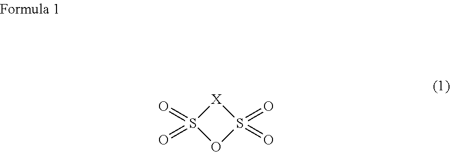
where X is a divalent hydrocarbon group or a derivative thereof. 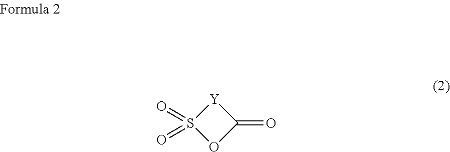
where Y is a divalent hydrocarbon group or a derivative thereof.

15. An electrical vehicle moving with the use of a secondary battery including a cathode, an anode, and an electrolytic solution as a power source,
wherein the electrolytic solution contains chlorine ions together with a nonaqueous solvent and an electrolyte salt,
the nonaqueous solvent contains one or both of sulfonic acid anhydrides shown in Formula 1 and Formula 2, and
a content of the chlorine ions is 5000 wt ppm or less. 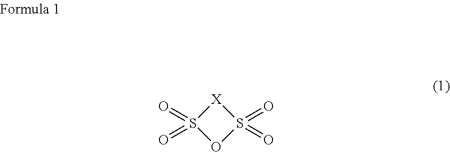
where X is a divalent hydrocarbon group or a derivative thereof. 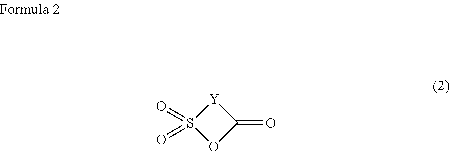
where Y is a divalent hydrocarbon group or a derivative thereof.

16. An electric power storage system using a secondary battery including a cathode, an anode, and an electrolytic solution as a power storage source,
wherein the electrolytic solution contains chlorine ions together with a nonaqueous solvent and an electrolyte salt,
the nonaqueous solvent contains one or both of sulfonic acid anhydrides shown in Formula 1 and Formula 2, and
a content of the chlorine ions is 5000 wt ppm or less. 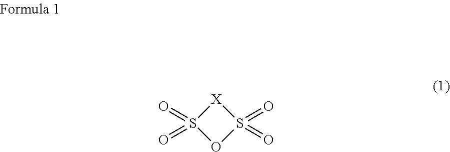
where X is a divalent hydrocarbon group or a derivative thereof. 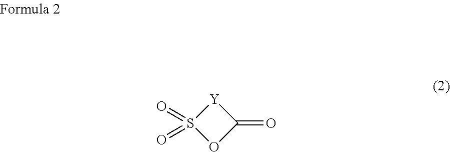
where Y is a divalent hydrocarbon group or a derivative thereof.
